(19) United States
(12) Patent Application Publication
(10) Pub. No.: US 2021/0120405 A1
(43) Pub. Date: Apr. 22, 2021

(54) SECURE FINE TIMING MEASUREMENTS

(71) Applicant: QUALCOMM Incorporated, San Diego, CA (US)

(72) Inventors: Youhan KIM, Saratoga, CA (US); Alireza RAISSINIA, Monte Sereno, CA (US); Xiaoxin ZHANG, Sunnyvale, CA (US); Vincent Knowles Jones, IV, Redwood City, CA (US)

(21) Appl. No.: 17/076,682

(22) Filed: Oct. 21, 2020

Related U.S. Application Data
(60) Provisional application No. 62/924,610, filed on Oct. 22, 2019.

(51) Int. Cl. H04W 12/00; H04W 24/08; H04W 72/04; H04L 5/00; H04L 27/26; H04W 76/10; H04W 12/08

(52) U.S. Cl. CPC H04W 12/00502; H04W 24/08; H04W 72/0446; H04W 84/12; H04L 27/2605; H04W 76/10; H04W 12/08; H04L 5/0053

(57) ABSTRACT

This disclosure provides systems, devices, apparatus and methods, including computer programs encoded on storage media, for initiating a secure FTM session between at least first and second STAs. A first STA initiates, with a second STA, a secure FTM session. The first STA receives a plurality of FTM packets from the second STA, each of the plurality of FTM packets including at least one preamble subject to a respective first CSD. The first STA transmits, to the second STA, an ACK for each of plurality of FTM packets. The first STA receives a measurement report including a ToD offset by the respective first CSD for each of the plurality of FTM packets, and a ToA at the second STA of each of a plurality of ACKs. The first STA determines a RTT between the first and second STAs based on the offset ToD and the ToA.

### CROSS REFERENCE TO RELATED APPLICATIONS

This application claims priority to U.S. Provisional Application No. 62/924,610 titled “SECURE FINE TIMING MEASUREMENTS,” filed Oct. 22, 2019, which is assigned to the assignee hereof, and incorporated herein by reference in its entirety.

### TECHNICAL FIELD

This disclosure relates generally to wireless communications, and more specifically, to secure fine timing measurements (FTMs).

### DESCRIPTION OF THE RELATED TECHNOLOGY

A wireless local area network (WLAN) may be formed by one or more access points (APs) that provide a shared wireless communication medium for use by a number of client devices also referred to as stations (STAs). The basic building block of a WLAN conforming to the Institute of Electrical and Electronics Engineers (IEEE) 802.11 family of standards is a Basic Service Set (BSS), which is managed by an AP. Each BSS is identified by a service set identifier (SSID) that is advertised by the AP. An AP periodically broadcasts beacon frames to enable any STAs within wireless range of the AP to establish and/or maintain a communication link with the WLAN.

Some wireless networks may be configured to support ranging operations. Ranging operations may involve an exchange of fine timing measurement (FTM) frames between at least a pair of STAs (e.g., an initiating STA and a responding STA). The initiating STA may send an FTM request to the responding STA, and the responding STA may send a number of FTM frames to the initiating STA. The initiating STA may then determine a range or distance between itself and the responding STA based on the FTM frames exchanged between the initiating STA and the responding STA. The ranging operation may allow the initiating STA to determine if the responding STA is within a service range of the initiating STA. However, FTM frames are not encrypted and may be susceptible to an attack from an attacking device. Furthermore, the attacking device may send a signal to the initiating STA in an effort to trick the initiating STA that the signal from the attacking device is actually from the responding STA, such that the attacking device may appear as the responding STA at a distance closer than the actual responding STA and within the service range of the initiating STA.

### SUMMARY

The systems, methods and devices of this disclosure each have several innovative aspects, no single one of which is solely responsible for the desirable attributes disclosed herein.

One innovative aspect of the subject matter described in this disclosure can be implemented in a method for wireless communication. In some implementations, the method includes a method for wireless communication at a wireless device at a first station (STA). The method includes initiating, with a second STA, a secure fine timing measurement (FTM) session. The method includes receiving, from the second STA, a plurality of FTM packets during the secure FTM session, each FTM packet of the plurality of FTM packets including a respective preamble subject to a respective first cyclic shift delay (CSD). The method includes transmitting, to the second STA, a plurality of acknowledgements (ACKs) including an ACK for each FTM packet of the plurality of FTM packets. The method includes receiving, from the second STA during the FTM session, a measurement report that includes, for each FTM packet of the plurality of FTM packets, a respective time of departure (ToD) that is offset by the respective first CSD for the FTM packet, and, for each ACK of the plurality of ACKs, a respective time of arrival (ToA) of the ACK at the second STA. The method includes determining a round trip time (RTT) between the first STA and the second STA based on the received ToDs offset by the respective first CSDs and based on the received ToAs.

Another innovative aspect of the subject matter described in this disclosure can be implemented in a wireless communication device. In some implementations, the wireless communication device includes at least one processor, and at least one memory communicatively coupled with the at least one processor and storing processor-readable code that, when executed by the at least one processor, may cause the wireless communication device to initiate, with a second STA, a secure FTM session. The at least one processor may cause the wireless communication device to receive, from the second STA, a plurality of FTM packets during the secure FTM session, each FTM packet of the plurality of FTM packets including a respective preamble subject to a respective first CSD. The at least one processor may cause the wireless communication device to transmit, to the second STA, a plurality of ACKs including an ACK for each FTM packet of the plurality of FTM packets. The at least one processor may cause the wireless communication device to receive, from the second STA during the FTM session, a measurement report that includes, for each FTM packet of the plurality of FTM packets, a respective ToD that is offset by the respective first CSD for the FTM packet, and, for each ACK of the plurality of ACKs, a respective ToA of the ACK at the second STA. The at least one processor may cause the wireless communication device to determine a RTT between the first STA and the second STA based on the received ToDs offset by the respective first CSDs and based on the received ToAs

Another innovative aspect of the subject matter described in this disclosure can be implemented in a tangible computer-readable storage medium comprising non-transitory processor-executable code operable to initiate, with a second STA, a secure FTM session. The non-transitory processor-executable code may be operable to receive, from the second STA, a plurality of FTM packets during the secure FTM session, each FTM packet of the plurality of FTM packets including a respective preamble subject to a respective first CSD. The non-transitory processor-executable code may be operable to transmit, to the second STA, a plurality of ACKs including an ACK for each FTM packet of the plurality of FTM packets. The non-transitory processor-executable code may be operable to receive, from the second STA during the FTM session, a measurement report that includes, for each FTM packet of the plurality of FTM packets, a respective ToD that is offset by the respective first CSD for the FTM packet, and, for each ACK of the plurality of ACKs, a respective ToA of the ACK at the second STA. The non-transitory processor-executable code may be operable to determine a RTT between the first STA and the second STA based on the received ToDs offset by the respective first CSDs and based on the received ToAs.

In some implementations, the methods, wireless communication devices and computer-readable storage media may be configured to determine a respective ToA t₂ of each FTM packet of the plurality of FTM packets from the second STA, the respective ToA t₂ being subject to the respective first CSD; determine a respective ToD t₃ of each ACK of the plurality of ACKs; determine a first difference between the respective t₄ of each ACK of the plurality of ACKs transmitted to the second STA and a respective t₁ for each FTM packet of the plurality of FTM packets subject to the respective first CSD; and determine a second difference between the ToD t₃ of each ACK of the plurality of ACKs and the respective ToA t₂ of a respective one of the plurality of FTM packets from the second STA subject to the first CSD. The RTT between the first STA and the second STA may be based on a third difference between the first difference and the second difference. The received ToD for each of the plurality of FTM packets subject to the respective first CSD is a respective t₁, and the received ToA of the ACK for each of the plurality of ACKs transmitted to the second STA is a respective t₄.

In some implementations, the methods, wireless communication devices and computer-readable storage media may be configured to determine an excess timing error (β) according to β=t2+t3−t4−t1−2ϕ, where ϕ is a first threshold, and where the wireless communication device determines the RTT based on |β| being less than a second threshold ε.

In some implementations, the methods, wireless communication devices and computer-readable storage media may be configured to randomize the first CSD in each of the plurality of FTM packets.

In some implementations, the methods, wireless communication devices and computer-readable storage media, the initiation of the FTM session includes transmitting an FTM request that indicates a number N of FTM transmissions for the FTM session, where the plurality of FTM packets consists of N FTM packets and the plurality of ACKs consists of N ACKs.

In some implementations of the methods, wireless communication devices and computer-readable storage media, transmitting the plurality of ACKs includes transmitting each ACK of the plurality of ACKs in a respective packet that includes a preamble subject to a respective second CSD, where the ToA of each ACK of the plurality of ACKs is offset due to the respective second CSD, and where the determination of the RTT between the first STA and the second STA is based on the ToA of each ACK of the plurality of ACKs.

In some implementations, the methods, wireless communication devices and computer-readable storage media may be configured to determine a ToA t₂ of each of the plurality of FTM packets from the second STA, the determined ToA t₂ being subject to the respective first CSD; determine a ToD t₃ of each of the plurality of ACKs; offset the ToD t₃ by the respective second CSD to obtain an offsetting ToD t₃ of each of the plurality of ACKs; determine a first difference between the received ToA t₄ of the ACK for each of the plurality of ACKs subject to the respective second CSD transmitted to the second STA and the received offset ToD t₁ for each of the plurality of FTM packets subject to the respective first CSD; and determine a second difference between the offsetting ToD t₃ of each of the plurality of ACKs and the ToA t₂ of each of the plurality of FTM packets subject to the first CSD from the second STA, where the RTT between the first STA and the second STA is based on a third difference between the first difference and the second difference, where the received offset ToD for each of the plurality of FTM packets subject to the respective first CSD is t₁ and the received ToA of the ACK for each of the plurality of ACKs subject to the respective second CSD transmitted to the second STA is t₄.

In some implementations of the methods, wireless communication devices and computer-readable storage media, the measurement report is encrypted, and the method includes decrypting the measurement report to obtain the respective ToD for each FTM packet of the plurality of FTM packets and to obtain the respective ToA of each ACK of the plurality of ACKs transmitted to the second STA.

In some implementations of the methods, wireless communication devices and computer-readable storage media, the determination of the distance includes determining a plurality of RTTs between the first STA and the second STA, each determined RTT of the plurality of RTTs being based on a respective FTM packet of the plurality of FTM packets and the respective ACK transmitted for the FTM packet; determining a set of RTTs of the plurality of RTTs that are consistent with each other; and determining a distance between the first STA and the second STA based on the set of RTTs.

In some implementations of the methods, wireless communication devices and computer-readable storage media, the determination of the distance includes determining a plurality of RTTs between the first STA and the second STA, each determined RTT of the plurality of RTTs being based on an individual set of a received one of the FTM packets and the ACK transmitted for the respective FTM packet, determining whether the determined RTTs are consistent with each other, where the distance between the first STA and the second STA is determined based on the determined RTTs being consistent with each other.

In some implementations of the methods, wireless communication devices and computer-readable storage media, the initiation of the FTM session with the second STA includes indicating to the second STA a minimum received signal strength (RSS) or a maximum path loss, and receiving a confirmation from the second STA to set up the FTM session based on one or both of the RSS being greater than the minimum RSS or the path loss being less than the maximum path loss.

Another innovative aspect of the subject matter described in this disclosure can be implemented in a method for wireless communication. In some implementations, the method includes a method for wireless communication at a wireless device at a first STA. The method includes receiving, from a second STA, an indication initiating a secure FTM session. The method includes transmitting a plurality of FTM packets to the second STA during the secure FTM session, each FTM packet of the plurality of FTM packets including a respective preamble subject to a respective first CSD. The method includes receiving, from the second STA, a plurality of ACKs including an ACK for each FTM packet of the plurality of FTM packets. The method includes transmitting, to the second STA during the FTM session, a measurement report that includes, for each FTM packet of the plurality of FTM packets, a respective ToD that is offset by the respective first CSD for the FTM packet and, for each ACK of the plurality of ACKs, a ToA of the ACK at the first STA.

Another innovative aspect of the subject matter described in this disclosure can be implemented in a wireless communication device. In some implementations, the wireless communication device includes at least one processor, and at least one memory communicatively coupled with the at least one processor and storing processor-readable code that, when executed by the at least one processor, may cause the wireless communication device to receive, from a second STA, a fine timing measurement (FTM) request that initiates a secure FTM session. The at least one processor may cause the wireless communication device to transmit a plurality of FTM packets to the second STA during the secure FTM session, each FTM packet of the plurality of FTM packets including a respective preamble subject to a respective first CSD. The at least one processor may cause the wireless communication device to receive, from the second STA, a plurality of ACKs including an ACK for each FTM packet of the plurality of FTM packets. The at least one processor may cause the wireless communication device to transmit, to the second STA during the FTM session, a measurement report that includes, for each FTM packet of the plurality of FTM packets, a respective ToD that is offset by the respective first CSD for the FTM packet and, for each ACK of the plurality of ACKs, a ToA of the ACK at the first STA.

Another innovative aspect of the subject matter described in this disclosure can be implemented in a tangible computer-readable storage medium comprising non-transitory processor-executable code operable to receive, from a second STA, a FTM request that initiates a secure FTM session. The non-transitory processor-executable code may be operable to transmit a plurality of FTM packets to the second STA during the secure FTM session, each FTM packet of the plurality of FTM packets including a respective preamble subject to a respective first CSD. The non-transitory processor-executable code may be operable to receive, from the second STA, a plurality of ACKs including an ACK for each FTM packet of the plurality of FTM packets. The non-transitory processor-executable code may be operable to transmit, to the second STA during the FTM session, a measurement report that includes, for each FTM packet of the plurality of FTM packets, a respective ToD that is offset by the respective first CSD for the FTM packet and, for each ACK of the plurality of ACKs, a ToA of the ACK at the first STA.

In some implementations of the methods, wireless communication devices and computer-readable storage media, receiving the indication initiating the FTM session includes receiving an indication of a minimum RSS or a maximum path loss, determining whether a signal received during the initiation from the first STA has one or both of an RSS greater than the minimum RSS or a path loss less than the maximum path loss, and transmitting a confirmation to the second STA to set up the secure FTM session based on one or both of the RSS being greater than the minimum RSS or the path loss being less than the maximum path loss.

In some implementations, the methods, wireless communication devices and computer-readable storage media may be configured to randomly generate the respective first CSD for each FTM packet of the plurality of FTM packets.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2A shows an example frame usable for communications between an access point (AP) and a number of stations (STAs).

FIG. 2B shows another example frame usable for communications between an AP and a number of STAs.

FIG. 3 shows a pictorial diagram of another example wireless communication network.

FIG. 4 shows a block diagram of an example access point (AP) for use in wireless communication.

FIG. 5 shows a block diagram of an example (STA) for use in wireless communication.

FIG. 6 shows a timing diagram illustrating an example process for performing a ranging operation.

FIG. 7 shows a timing diagram illustrating an example fine timing measurement (FTM) process according to some implementations.

FIG. 8 is a diagram illustrating an example FTM process according to some implementations.

FIGS. 9A-9F show flowcharts illustrating an example process for initiating a secure FTM session according to some implementations.

FIGS. 10A and 10B show flowcharts illustrating an example process for performing a secure FTM session according to some implementations.

Like reference numbers and designations in the various drawings indicate like elements.

### DETAILED DESCRIPTION

The following description is directed to certain implementations for the purposes of describing innovative aspects of this disclosure. However, a person having ordinary skill in the art will readily recognize that the teachings herein can be applied in a multitude of different ways. The described implementations can be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G standards, among others. The described implementations can be implemented in any device, system or network that is capable of transmitting and receiving RF signals according to one or more of the following technologies or techniques: code division multiple access (CDMA), time division multiple access (TDMA), frequency division multiple access (FDMA), orthogonal frequency division multiple access (OFDMA), single-user (SU) multiple-input multiple-output (MIMO) and multi-user (MU) MIMO. The described implementations also can be implemented using other wireless communication protocols or RF signals suitable for use in one or more of a wireless personal area network (WPAN), a wireless local area network (WLAN), a wireless wide area network (WWAN), or an internet of things (TOT) network.

A conventional ranging operation involving an exchange of fine timing measurement (FTM) frames between at least a pair of STAs (e.g., an initiating STA and a responding STA) may be susceptible to an attack from an attacking device. For example, because FTM frames are not encrypted, the attacking device may execute a type of man-in-the-middle attack. The attacking device may send a signal to the initiating STA in an effort to trick the initiating STA that the signal from the attacking device is actually from the responding STA, such that the attacking device may appear as the responding STA at a distance closer than the actual responding STA and within the service range of the initiating STA. For instance, the attacking device, when the packets used for timing measurements are being transmitted, may transmit a replica of the packet to be transmitted from the responding STA with a slightly earlier timing to trick the initiating STA into believing that the distance between the initiating STA and the responding STA (or attacking device pretending to be the responding STA) is shorter than the actual distance. Accordingly, the attacking device may trick the initiating STA into providing a service to the attacking device in response to detecting the shorter distance.

Various implementations relate generally to establishing a secure FTM session between at least a first STA and a second STA. For example, the first STA may be an initiating STA, and the second STA may be a responding STA. The secure FTM session may utilize a respective first cyclic shift delay (CSD) for each FTM packet. The first cyclic shift delay may be generated by the responding STA and may not be known to the initiating STA until after measurements are performed. For example, the responding STA may randomly generate the first CSD. Accordingly, a potential attacking device may also not know the CSD of the FTM packets. In some implementations, the initiating device may utilize a second CSD for each acknowledgment (ACK) corresponding to one of the FTM packets. The second cyclic shift delay may be generated by the initiating STA and applied to each ACK. For example, the initiating STA may randomly generate the respective second CSD for each ACK. Accordingly, a potential attacking device may also not know the CSD of the ACKs. The responding STA may send a measurement report at the end of the secure FTM session that includes a time of departure (ToD) offset by the first CSD for each of the FTM packets and a time of arrival (ToA) of each of the ACKs at the responding STA. The initiating device may determine a round trip time (RTT) based on the ToDs and the ToAs. Because an attacking device cannot obtain the first CSD or the second CSD, any replica FTM packets or ACKs transmitted by the attacking device will not be consistent with the measurement report. The initiating device may detect a potential attack based on measurements inconsistent with the measurement report. In some implementations, the measurement report may be encrypted to prevent a potential attacking device from recovering the measurements.

Particular implementations of the subject matter described in this disclosure can be implemented to realize one or more of the following potential advantages. In some implementations, the described techniques provide improvements over the existing IEEE 802.11 FTM process to enhance the security of the FTM process. For example, the described techniques herein may prevent an initiating STA from determining a RTT or distance to a responding STA based on timing measurement misinformation resulting from an attack on the initiating STA or the responding STA. For example, the random CSD allows the initiating STA to detect a spoofed or replicated timing measurement having incorrect timing measurement information. The initiating STA may be able to determine that an attack on timing measurement information has occurred and may disregard such measurement information.

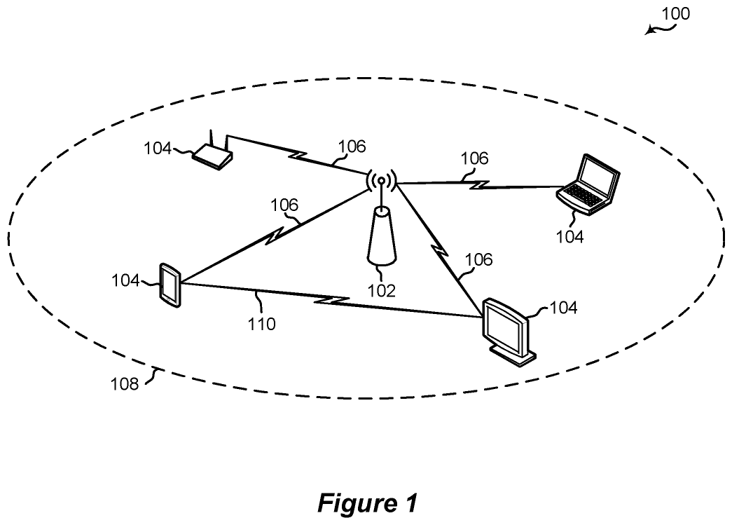

FIG. 1 shows a block diagram of an example wireless communication network 100. According to some aspects, the wireless communication network 100 can be an example of a wireless local area network (WLAN) such as a Wi-Fi network (and will hereinafter be referred to as WLAN 100). For example, the WLAN 100 can be a network implementing at least one of the IEEE 802.11 family of standards (such as that defined by the IEEE 802.11-2016 specification or amendments thereof). The WLAN 100 may include numerous wireless communication devices such as an access point (AP) 102 and multiple stations (STAs) 104. Each of the STAs 104 also may be referred to as a mobile station (MS), a mobile device, a mobile handset, a wireless handset, an access terminal (AT), a user equipment (UE), a subscriber station (SS), or a subscriber unit, among other possibilities. The STAs 104 may represent various devices such as mobile phones, personal digital assistant (PDAs), other handheld devices, netbooks, notebook computers, tablet computers, laptops, display devices (for example, TVs, computer monitors, navigation systems, among others), music or other audio or stereo devices, remote control devices (“remotes”), printers, kitchen or other household appliances, key fobs (for example, for passive keyless entry and start (PKES) systems), among other possibilities.

A single AP 102 and an associated set of STAs 104 may be referred to as a basic service set (BSS), which is managed by the respective AP. The BSS is identified by a service set identifier (SSID) that is advertised by the AP 102. The AP 102 periodically broadcasts beacon frames (“beacons”) to enable any STAs 104 within wireless range of the AP 102 to establish and/or maintain a respective communication link 106 (hereinafter also referred to as a “Wi-Fi link”) with the AP. The various STAs 104 in the WLAN are able to communicate with external networks as well as with one another via the AP 102 and respective communication links 106. To establish a communication link 106 with an AP 102, each of the STAs 104 is configured to perform passive or active scanning operations (“scans”) on frequency channels in one or more frequency bands (for example, the 2.4 GHz, 5 GHz, 6 GHz or 60 GHz bands). To perform passive scanning, a STA 104 listens for beacons, which are transmitted by respective APs 102 at a periodic time interval referred to as the target beacon transmission time (TBTT) (measured in time units (TUs) where one TU is equal to 1024 microseconds (s)). To perform active scanning, a STA 104 generates and sequentially transmits probe requests on each channel to be scanned and listens for probe responses from APs 102. Each STA 104 may be configured to identify or select an AP 102 with which to associate based on the scanning information obtained through the passive or active scans, and to perform authentication and association operations to establish a Wi-Fi link with the selected AP.

FIG. 1 additionally shows an example coverage area 108 of the AP 102, which may represent a basic service area (BSA) of the WLAN 100. While only one AP 102 is shown, the WLAN network 100 can include multiple APs 102. As a result of the increasing ubiquity of wireless networks, a STA 104 may have the opportunity to select one of many BSSs within range of the STA and/or select among multiple APs 102 that together form an extended service set (ESS) including multiple connected BSSs. An extended network station associated with the WLAN 100 may be connected to a wired or wireless distribution system that may allow multiple APs 102 to be connected in such an ESS. As such, a STA 104 can be covered by more than one AP 102 and can associate with different APs 102 at different times for different transmissions. Additionally, after association with an AP 102, a STA 104 also may be configured to periodically scan its surroundings to find a more suitable AP with which to associate. For example, a STA 104 that is moving relative to its associated AP 102 may perform a “roaming” scan to find another AP having more desirable network characteristics such as a greater received signal strength indicator (RSSI).

The APs 102 and STAs 104 may function and communicate (via the respective communication links 106) according to the IEEE 802.11 family of standards (such as that defined by the IEEE 802.11-2016 specification or amendments thereof including, but not limited to, 802.11ah, 802.11ay, 802.11ax, 802.11az, and 802.11ba). These standards define the WLAN radio and baseband protocols for the PHY and medium access control (MAC) layers. The APs 102 and STAs 104 transmit and receive frames (hereinafter also referred to as “Wi-Fi communications”) to and from one another in the form of physical layer convergence protocol (PLCP) protocol data units (PPDUs). Each PPDU is a composite frame that includes a PLCP preamble and header as well as one or more MAC protocol data units (MPDUs).

The APs 102 and STAs 104 in the WLAN 100 may transmit PPDUs over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. Some implementations of the APs 102 and STAs 104 described herein also may communicate in other frequency bands, such as the 6 GHz band, which may support both licensed and unlicensed communications. The APs 102 and STAs 104 also can be configured to communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11n, 802.11ac and 802.11ax standard amendments may be transmitted over the 2.4 and 5 GHz bands, each of which is divided into multiple 20 MHz channels. As such, these PPDUs are transmitted over a physical channel having a minimum bandwidth of 20 MHz. But larger channels can be formed through channel bonding. For example, PPDUs conforming to the IEEE 802.11n, 802.11ac and 802.11ax standard amendments may be transmitted over physical channels having bandwidths of 40 MHz, 80 MHz or 160 MHz by bonding together two or more 20 MHz channels. Additionally, in some implementations the AP 102 can transmit PPDUs to multiple STAs 104 simultaneously using one or both of multi user (MU) multiple-input multiple-output (MIMO) (also known as spatial multiplexing) and orthogonal frequency division multiple access (OFDMA) schemes.

Each PPDU typically includes a PLCP preamble, a PLCP header and a MAC header prior to the accompanying data. The information provided in the preamble and headers may be used by a receiving device to decode the subsequent data. A legacy portion of the preamble may include a legacy short training field (STF) (L-STF), a legacy long training field (LTF) (L-LTF), and a legacy signaling field (L-SIG). The legacy preamble may be used for packet detection, automatic gain control and channel estimation, among other uses. The legacy preamble may also be used to maintain compatibility with legacy devices. In instances in which PPDUs are transmitted over a bonded channel, the L-STF, L-LTF, and L-SIG fields may be duplicated and transmitted in each of the plurality of component channels. For example, in IEEE 802.11n, 802.11ac or 802.11ax implementations, the L-STF, L-LTF, and L-SIG fields may be duplicated and transmitted in each of the component 20 MHz channels. The format of, coding of, and information provided in the non-legacy portion of the preamble is based on the particular IEEE 802.11 protocol.

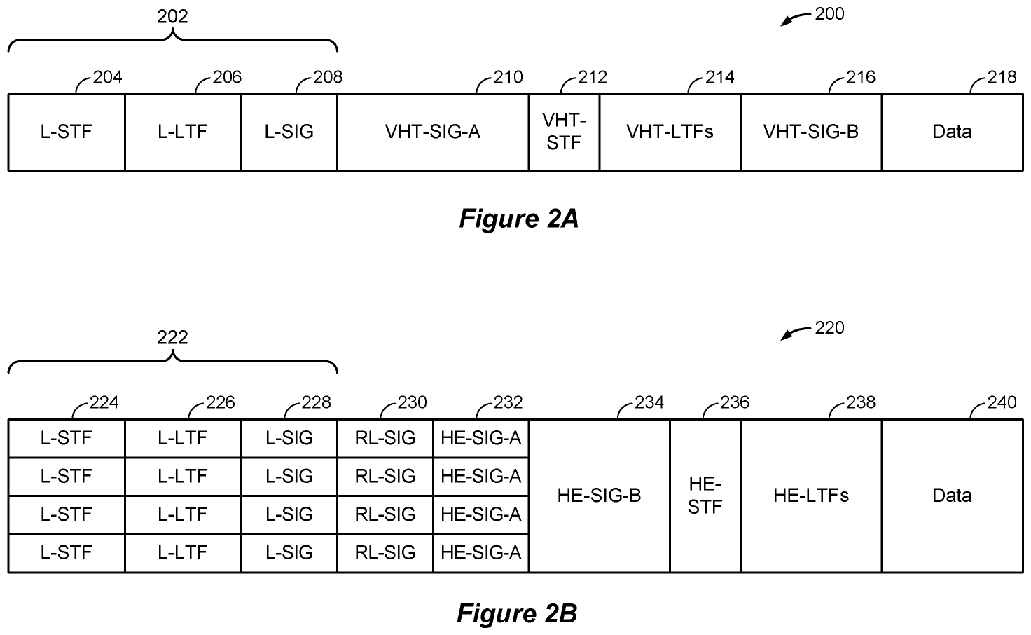

FIG. 2A shows an example frame 200 usable for communications between an AP 102 and each of a number of STAs 104. For example, the frame 200 can be formatted as a very high throughput (VHT) frame in accordance with the IEEE 802.11ac amendment to the IEEE 802.11 standard. The frame 200 includes a legacy preamble portion 202 that includes L-STF 204, L-LTF 206, and L-SIG 208. The frame 200 further includes a non-legacy preamble portion that includes a first very high throughput (VHT) signaling field (VHT-SIG-A) 210, a VHT short training field (VHT-STF) 212, a number of VHT long training fields (VHT-LTFs) 214 and a second VHT signaling field (VHT-SIG-B) 216 encoded separately from the VHT-SIG-A field 210. Like the L-STF 204, L-LTF 206, and L-SIG 208, the information in the VHT-SIG-A field 210 may be duplicated and transmitted in each of the component 20 MHz channels in instances involving the use of a bonded channel. The frame 200 also can include a payload or data field 218 after the preamble. The data field 218 can include medium access control (MAC) protocol data units (MPDUs), for example, in the form of an aggregated MPDU (AMPDU).

The VHT-SIG-A field 210 may indicate to 802.11ac-compatible STAs 104 that the frame 200 is an IEEE 802.11ac frame. The VHT-SIG-A field 210 includes information usable by an identified number of STAs 104 to decode the VHT-SIG-B field 216. The VHT-SIG-A field 210 also may include VHT WLAN signaling information usable by STAs 104 other than the identified number of STAs 104. The VHT-SIG-B field 216 may include VHT WLAN signaling information usable by a subset of the identified number of STAs 104 to decode data received in the data field 218. The number of VHT-LTFs 214 depends on the number of transmitted streams.

FIG. 2B shows another example frame 220 usable for communications between an AP 102 and each of a number of stations 104. For example, the frame 220 can be formatted as a high efficiency (HE) frame in accordance with the IEEE 802.11ax amendment to the IEEE 802.11 standard. The example frame 200 may be used for multi-user (MU) simultaneous transmissions (for example, using multi-user orthogonal frequency division multiple access (MU-OFDMA) or multi-user multiple-input, multiple-output (MU-MIMO) techniques). In some aspects, the frame 200 may be an example of a trigger frame used by the AP 102 to initiate and synchronize uplink (UL) MU-OFDMA or UL MU-MIMO transmissions from the STAs 104 to the AP 102. Such trigger frames may thus enable multiple STAs 104 to send UL traffic to the AP 102 concurrently in time. A trigger frame may address one or more STAs 104 through respective association identifiers (AIDs), and may assign each AID one or more unique resource units (RUs) that can be used to send UL traffic to the AP 102. RUs may be defined in 2 MHz intervals. As such, in a 160 MHz channel, up to 74 RUs (such as 2 MHz, 26-tone RUs) may be allocated. Therefore, it may be possible to schedule as many as 74 STAs 104 for MU OFDMA transmissions. The AP also may designate one or more random access (RA) RUs that unscheduled STAs 104 may contend for. In other aspects, the frame 200 may be an example of a downlink (DL) MU PPDU, such as a DL MU-OFDMA PPDU or a DL MU-MIMO PPDU, used by an AP 102 to send data to multiple STAs 104 simultaneously in corresponding allocated RUs.

The frame 220 includes a legacy preamble portion 222 that includes L-STF 224, L-LTF 226, and L-SIG 228. The frame 220 further includes a non-legacy preamble portion that includes a repeated legacy signaling field (RL-SIG) 230, a first high efficiency signaling field (HE-SIG-A) 232, a second high efficiency signaling field (HE-SIG-B) 234 (encoded separately from the HE-SIG-A field 232), a high efficiency short training field (HE-STF) 236 and a number of high efficiency long training fields (HE-LTFs) 238. The RL-SIG field 230 may indicate to a STA 104 that the frame 220 is an IEEE 802.11ax frame. Like the L-STF 224, L-LTF 226, and L-SIG 228, the information in the RL-SIG field 230 and the HE-SIG-A field 232 may be duplicated and transmitted in each of the component 20 MHz channels in instances involving the use of a bonded channel. The frame 220 also can include a payload or data field 240 after the preamble. The data field 240 can include multiple MPDUs, for example, in the form of AMPDUs.

An AP 102 may use an HE-SIG-A field 232 to indicate to multiple identified STAs 104 that the AP is scheduling UL or DL resources. The HE-SIG-A field 232 may be decoded by each HE-compatible STA 104 served by the AP 102. The HE-SIG-A field 232 includes information usable by the identified STAs 104 to decode associated HE-SIG-B fields 234. For example, the HE-SIG-A field 232 may indicate the frame format, including locations and lengths of HE-SIG-B fields 234, available channel bandwidths, modulation and coding schemes (MCS), among other possibilities. The HE-SIG-A field 232 also may include HE WLAN signaling information usable by STAs 104 other than the number of STAs 104 identified in the frame 200.

The HE-SIG-B fields 234 carry STA-specific scheduling information such as, for example, per-user MCS values and per-user RU allocation information. In the context of DL MU-OFDMA, such information enables the respective STAs 104 to identify and decode corresponding RUs in the data field 240. Each HE-SIG-B field 234 includes a common field and at least one STA-specific (“user-specific”) field. The common field can indicate RU distributions to multiple STAs 104, indicate the RU assignments in the frequency domain, indicate which RUs are allocated for MU-MIMO transmissions and which RUs correspond to MU-OFDMA transmissions, the number of users in allocations, among other possibilities. The common field may be encoded with common bits, cyclic redundancy check (CRC) bits, and tail bits. The user-specific fields are assigned to particular STAs 104 and used to schedule specific RUS and to indicate the scheduling to other WLAN devices. Each user-specific field may include multiple user block fields (which may be followed by padding). Each user block field may include two user fields that contain information for two STAs to decode their respective RU payloads.

In some cases, aspects of transmissions may vary based on a distance between a transmitter (for example, AP 102) and a receiver (for example, STA 104). WLAN 100 may otherwise generally benefit from AP 102 having information regarding the location of the various STAs 104 within coverage area 108. In some examples, relevant distances may be computed using RTT-based ranging procedures. As an example, WLAN 100 may offer such functionality that produces accuracy on the order of one meter (or even centimeter-level accuracy). The same (or similar) techniques employed in WLAN 100 may be applied across other radio access technologies (RATs).

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) connections. In some cases, ad hoc networks may be implemented within a larger wireless network such as the WLAN 100. In such implementations, while the STAs 104 may be capable of communicating with each other through the AP 102 using communication links 106, STAs 104 also can communicate directly with each other via direct wireless links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless links 110 include Wi-Fi Direct connections, connections established by using a Wi-Fi Tunneled Direct Link Setup (TDLS) link, and other P2P group connections.

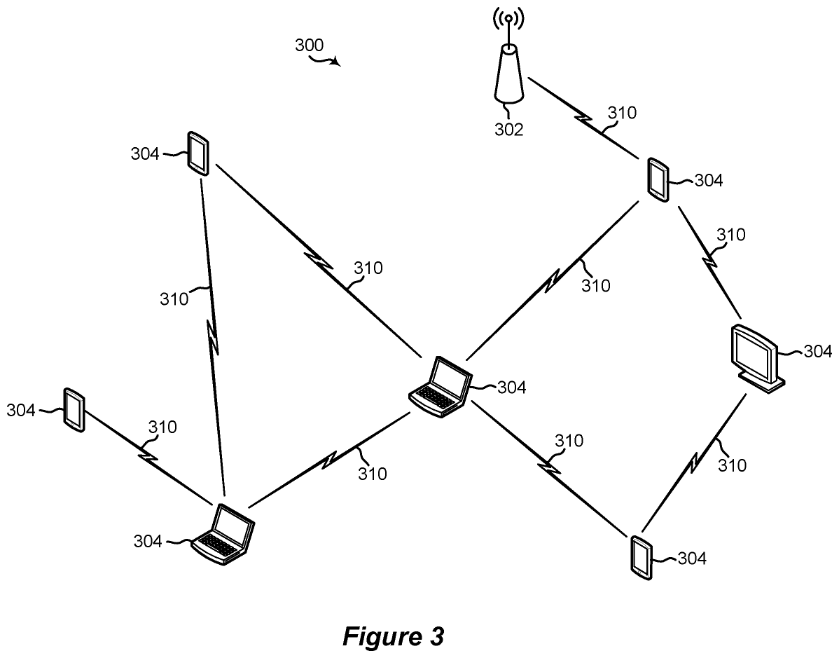

FIG. 3 shows a pictorial diagram of another example wireless communication network 300. According to some aspects, the wireless communication network 300 can be an example of a WLAN. For example, the wireless network 300 can be a network implementing at least one of the IEEE 802.11 family of standards. The wireless network 300 may include multiple STAs 304. As described above, each of the STAs 304 also may be referred to as a mobile station (MS), a mobile device, a mobile handset, a wireless handset, an access terminal (AT), a user equipment (UE), a subscriber station (SS), or a subscriber unit, among other possibilities. The STAs 304 may represent various devices such as mobile phones, personal digital assistant (PDAs), other handheld devices, netbooks, notebook computers, tablet computers, laptops, display devices (for example, TVs, computer monitors, navigation systems, among others), music or other audio or stereo devices, remote control devices (“remotes”), printers, kitchen or other household appliances, key fobs (for example, for passive keyless entry and start (PKES) systems), among other possibilities.

The wireless network 300 is an example of a peer-to-peer (P2P), ad hoc or mesh network. STAs 304 can communicate directly with each other via P2P wireless links 310 (without the use of an intermediary AP). In some implementations, the wireless network 300 is an example of a neighbor awareness network (NAN). NANs operate in accordance with the Wi-Fi Alliance (WFA) Neighbor Awareness Networking (also referred to as NAN) standard specification. NAN-compliant STAs 304 (hereinafter also simply “NAN devices 304”) transmit and receive NAN communications (for example, in the form of Wi-Fi packets including frames conforming to an IEEE 802.11 standard such as that defined by the IEEE 802.11-2016 specification or amendments thereof) to and from one another via wireless P2P links 310 (hereinafter also referred to as “NAN links”) using a data packet routing protocol, such as Hybrid Wireless Mesh Protocol (HWMP), for path selection.

A NAN network generally refers to a collection of NAN devices that share a common set of NAN parameters including: the time period between consecutive discovery windows, the time duration of the discovery windows, the NAN beacon interval, and the NAN discovery channel(s). A NAN ID is an identifier signifying a specific set of NAN parameters for use within the NAN network. NAN networks are dynamically self-organized and self-configured. NAN devices 304 in the network automatically establish an ad-hoc network with other NAN devices 304 such that network connectivity can be maintained. Each NAN device 304 is configured to relay data for the NAN network such that various NAN devices 304 may cooperate in the distribution of data within the network. As a result, a message can be transmitted from a source NAN device to a destination NAN device by being propagated along a path, hopping from one NAN device to the next until the destination is reached.

In some instances, NAN devices 304 may exchange service discovery frames to ascertain whether both devices support ranging operations. NAN devices 304 may perform such ranging operations (“ranging”) during the discovery windows. The ranging may involve an exchange of fine timing measurement (FTM) frames (such as those defined in IEEE 802.11-REVmc). For example, a first NAN device 304 may transmit unicast FTM requests to multiple peer NAN devices 304. The peer NAN devices 304 may then transmit responses to the first NAN device 304. The first NAN device 304 may then exchange a number of FTM frames with each of the peer NAN devices 304. The first NAN device 304 may then determine a range between itself and each of the peer devices 304 based on the FTM frames and transmit a range indication to each of the peer NAN devices 304. For example, the range indication may include a distance value or an indication as to whether a peer NAN device 304 is within a service discovery threshold (for example, 3 meters(m)) of the first NAN device 304. NAN links between NAN devices within the same NAN cluster may persist over multiple discovery windows as long as the NAN devices remain within the service discovery thresholds of one another and synchronized to the anchor master of the NAN cluster.

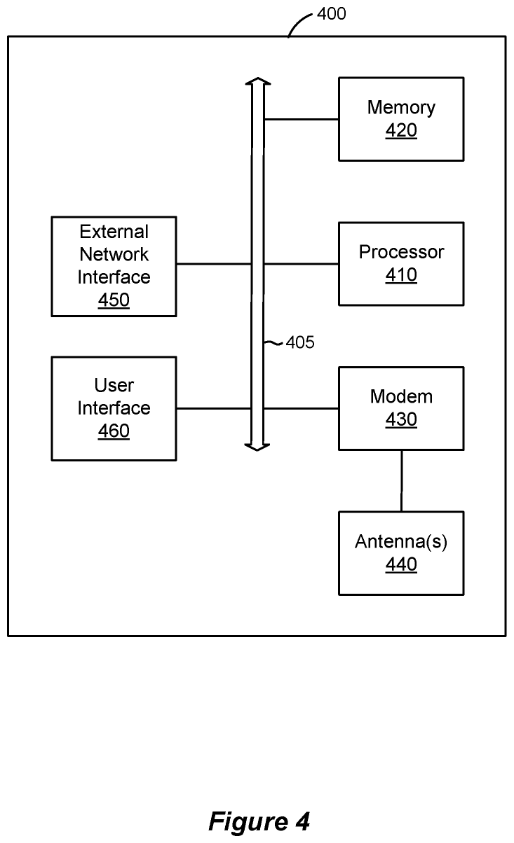

FIG. 4 shows a block diagram of an example access point (AP) 400 for use in wireless communication. For example, the AP 400 may be an example of aspects of the AP 102 described with reference to FIG. 1. The AP 400 is capable of transmitting and receiving wireless communications (for example, in the form of wireless packets), as well as of encoding and decoding such communications. For example, the wireless communications can include Wi-Fi packets including frames conforming to an IEEE 802.11 standard (such as that defined by the IEEE 802.11-2016 specification or amendments thereof including, but not limited to, 802.11ah, 802.11ay, 802.11ax, 802.11az, and 802.11ba). The AP 400 includes at least one processor 410 (collectively “the processor 410”), at least one memory 420 (collectively “the memory 420”), at least one modem 430 (collectively “the modem 430”), at least one antenna 440 (collectively “the antenna 440”), at least one external network interface 450 (collectively “the network interface 450”) and, in some instances, a user interface (UI) 460. Each of the components (or “modules”) described with reference to FIG. 4 can communicate with other ones of the components, directly or indirectly, over at least one bus 405.

The processor 410 can include an intelligent hardware device such as, for example, a central processing unit (CPU), a microcontroller, an application-specific integrated circuit (ASIC), or a programmable logic device (PLD) such as a field programmable gate array (FPGA), among other possibilities. The processor 410 processes information received through the modem 430 and the external network interface 450. The processor 410 also can process information to be sent to the modem 430 for transmission through the antenna 440 and information to be sent to the external network interface 450. The processor 410 can generally be configured to perform various operations related to generating and transmitting a downlink frame and receiving an uplink frame.

The memory 420 can include random access memory (RAM) and read-only memory (ROM). The memory 420 also can store processor- or computer-executable software (SW) code containing instructions that, when executed by the processor 410, cause the processor to perform various functions described herein for wireless communication, including generation and transmission of a downlink frame and reception of an uplink frame.

The modem 430 is generally configured to modulate packets and to provide the modulated packets to the antenna 440 for transmission, as well as to demodulate packets received from the antenna 440 to provide demodulated packets. The modem 430 generally includes or is coupled with at least one radio frequency (RF) transmitter and at least one RF receiver, which may be combined into one or more transceivers, and which are in turn coupled to one or more antennas 440. For example, in some AP implementations, the AP 400 can include multiple transmit antennas (each with a corresponding transmit chain) and multiple receive antennas (each with a corresponding receive chain). The modem 430 can communicate bi-directionally, via the antenna 440, with at least one STA (such as the STA 104 described with reference to FIG. 1).

The modem 430 may include digital processing circuitry, automatic gain control (AGC), a demodulator, a decoder and a demultiplexer. The digital signals received from the transceivers are provided to digital signal processing circuitry configured to acquire a received signal, for example, by detecting the presence of the signal and estimating the initial timing and frequency offsets. The digital signal processing circuitry is further configured to digitally condition the digital signals, for example, using channel (narrowband) filtering, analog impairment conditioning, such as correcting for I/Q imbalance, and applying digital gain to ultimately obtain a narrowband signal. The output of the digital signal processing circuitry is fed to the AGC, which is configured to use information extracted from the digital signals, for example, in one or more received training fields, to determine an appropriate gain. The output of the digital signal processing circuitry also is coupled with the demodulator, which is configured to extract modulated symbols from the signal and to reverse map the symbols to points in a modulation constellation to provide demodulated bits. The demodulator is coupled with the decoder, which is configured to decode the demodulated bits to provide decoded bits, which are then fed to the demultiplexer for demultiplexing. The demultiplexed bits may then be provided to the processor 410 for processing, evaluation or interpretation, for example, by one or more host applications executing on the processor.

The AP 400 may communicate with a core or backhaul network through the external network interface 450 to gain access to external networks including the Internet. For example, the external network interface 450 may include one or both of a wired (for example, Ethernet) network interface or wireless (for example, LTE, 4G or 5G) network interface.

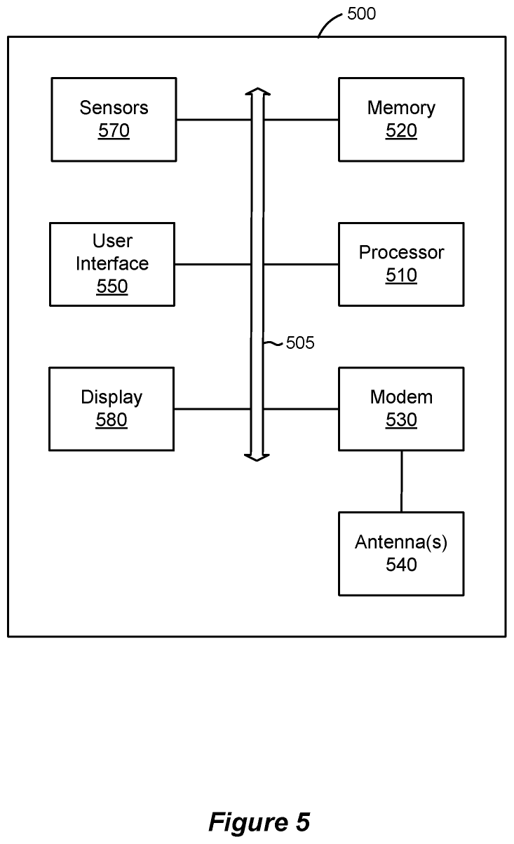

FIG. 5 shows a block diagram of an example wireless station (STA) 500 for use in wireless communication. For example, the STA 500 may be an example of aspects of the STA 104 or the STA 304 described with reference to FIGS. 1 and 3, respectively. The STA 500 is capable of transmitting and receiving wireless communications, as well as of encoding and decoding such communications. The wireless communications may conform to any of a number of different wireless communication protocols. For example, the STA 500 may be capable of transmitting and receiving Wi-Fi packets including frames conforming to an IEEE 802.11 standard, such as defined by the IEEE 802.11-2016 specification or amendments thereof including, but not limited to, 802.11ah, 802.11ay, 802.11ax, 802.11az, and 802.11ba). Additionally or alternatively, the STA 500 may be capable of transmitting and receiving Bluetooth packets conforming to a Bluetooth standard, such as defined in IEEE 802.15 or by the Bluetooth SIG. Additionally or alternatively, the STA 500 may be capable of transmitting and receiving wireless packets associated with the Long Term Evolution (LTE), International Mobile Telecommunications-Advanced (IMT-Advanced) 4G or 5G standards.

The STA 500 includes at least one processor 510 (collectively “the processor 510”), at least one memory 520 (collectively “the memory 520”), at least one modem 530 (collectively “the modem 530”) and at least one antenna 540 (collectively “the antenna 540”). In some implementations, the STA 500 additionally includes some or all of the following: a user interface (UI) 550 (such as a touchscreen or keypad), one or more sensors 570 (such as one or more inertial sensors, accelerometers, temperature sensors, pressure sensors, or altitude sensors), and a display 580. Each of the components (or “modules”) described with reference to FIG. 5 can communicate with one another, directly or indirectly, over at least one bus 505.

The processor 510 includes an intelligent hardware device such as, for example, a CPU, a microcontroller, an ASIC or a PLD such as an FPGA, among other possibilities. The processor 510 processes information received through the modem 530 as well as information to be sent to the modem 530 for transmission through the antenna 540. The processor 510 can be configured to perform various operations related to receiving a downlink frame and generating and transmitting an uplink frame.

The memory 520 can include RAM and ROM. The memory 520 also can store processor- or computer-executable SW code containing instructions that, when executed, cause the processor 510 to perform various functions described herein for wireless communication, including reception of a downlink frame and generation and transmission of an uplink frame.

The modem 530 is generally configured to modulate packets and provide the modulated packets to the antenna 540 for transmission, as well as to demodulate packets received from the antenna 540 to provide demodulated packets. The modem 530 generally includes at least one radio frequency (RF) transmitter and at least one RF receiver, which may be combined into one or more transceivers, and which are in turn coupled to one or more antennas 540. For example, in some implementations, the STA 500 can include multiple transmit antennas (each with a corresponding transmit chain) and multiple receive antennas (each with a corresponding receive chain). The modem 530 can communicate bi-directionally, via the antenna 540, with at least one AP (such as the AP 102 or AP 400 described with reference to FIGS. 1 and 4, respectively). As is described above, in some implementations, the modem also can communicate bi-directionally, via the antenna 540, with other STAs directly without the use of an intermediary AP.

The modem 530 may include digital processing circuitry, automatic gain control (AGC), a demodulator, a decoder and a demultiplexer. The digital signals received from the transceivers are provided to digital signal processing circuitry configured to acquire a received signal, for example, by detecting the presence of the signal and estimating the initial timing and frequency offsets. The digital signal processing circuitry is further configured to digitally condition the digital signals, for example, using channel (narrowband) filtering, analog impairment conditioning, such as correcting for I/Q imbalance, and applying digital gain to ultimately obtain a narrowband signal. The output of the digital signal processing circuitry is fed to the AGC, which is configured to use information extracted from the digital signals, for example, in one or more received training fields, to determine an appropriate gain. The output of the digital signal processing circuitry also is coupled with the demodulator, which is configured to extract modulated symbols from the signal and to reverse map the symbols to points in a modulation constellation to provide demodulated bits. The demodulator is coupled with the decoder, which is configured to decode the demodulated bits to provide decoded bits, which are then fed to the demultiplexer for demultiplexing. The demultiplexed bits may then be provided to the processor 510 for processing, evaluation or interpretation, for example, by one or more host applications executing on the processor.

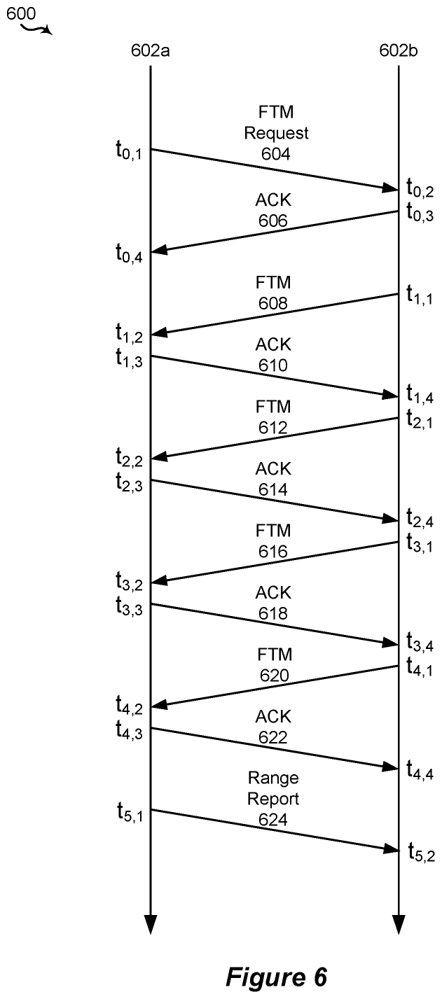

As described above, STAs 500 that are NAN-compliant perform ranging operations during discovery windows. The ranging operation may involve an exchange of fine timing measurement (FTM) frames (such as those defined in the IEEE 802.11mc specification or revisions or updates thereof). FIG. 6 shows a timing diagram illustrating an example process for performing a ranging operation 600. The process for the ranging operation 600 may be conjunctively performed by two wireless devices 602a and 602b, which may each be an example of a STA such as the NAN device 304 described with reference to FIG. 3 or the STA 500 described with reference to FIG. 5.

The ranging operation 600 begins with the first wireless device 602a transmitting an initial FTM range request frame 604 at time t_{0,1}. Responsive to successfully receiving the FTM range request frame 604 at time t_{0,2}, the second wireless device 602b responds by transmitting a first ACK 606 at time t_{0,3}, which the first wireless device 602a receives at time t_{0,4} The first wireless device 602a and the second wireless device 602b then exchange one or more FTM bursts, which may each include a number of exchanges of FTM action frames (hereinafter simply “FTM frames”) and corresponding ACKs. One or more of the FTM request frame 604 and the FTM action frames (hereinafter simply “FTM frames”) may include FTM parameters specifying various characteristics of the ranging operation 600.

In the example shown in FIG. 6, in a first exchange, beginning at time t_{1,1}, the second wireless device 602b transmits a first FTM frame 608. The second wireless device 602b records the time t_{1,1} as the time of departure (TOD) of the first FTM frame 608. The first wireless device 602a receives the first FTM frame 608 at time t_{1,2} and transmits a first acknowledgement frame (ACK) 610 to the second wireless device 602b at time t_{1,3}. The first wireless device 602a records the time t_{1,2} as the time of arrival (TOA) of the first FTM frame 608, and the time t_{1,3} as the TOD of the first ACK 610. The second wireless device 602b receives the first ACK 610 at time t_{1,4} and records the time t_{1,4} as the TOA of the first ACK 610.

Similarly, in a second exchange, beginning at time t_{2,1}, the second wireless device 602b transmits a second FTM frame 612. The second FTM frame 612 includes a first field indicating the TOD of the first FTM frame 608 and a second field indicating the TOA of the first ACK 610. The first wireless device 602a receives the second FTM frame 612 at time t_{2,2} and transmits a second ACK 614 to the second wireless device 602b at time t_{2,3}. The second wireless device 602b receives the second ACK 614 at time t_{2,4}. Similarly, in a third exchange, beginning at time t_{3,1}, the second wireless device 602b transmits a third FTM frame 616. The third FTM frame 616 includes a first field indicating the TOD of the second FTM frame 612 and a second field indicating the TOA of the second ACK 614. The first wireless device 602a receives the third FTM frame 616 at time t_{3,2} and transmits a third ACK 618 to the second wireless device 602b at time t_{3,3}. The second wireless device 602b receives the third ACK 618 at time t_{3,4}. Similarly, in a fourth exchange, beginning at time t_{4,1}, the second wireless device 602b transmits a fourth FTM frame 620. The fourth FTM frame 620 includes a first field indicating the TOD of the third FTM frame 616 and a second field indicating the TOA of the third ACK 618. The first wireless device 602a receives the fourth FTM frame 620 at time t_{4,2} and transmits a fourth ACK 622 to the second wireless device 602b at time t_{4,3}. The second wireless device 602b receives the fourth ACK 622 at time t_{4,4}.

The first wireless device 602a determines a range indication based on the TODs and TOAs described above. For example, in implementations or instances in which an FTM burst includes four exchanges of FTM frames as described above, the first wireless device 602a may be configured to determine a round trip time (RTT) between itself and the second wireless device 602b based on Equation 1 below.

RTT=⅓(Σₖ₌₁³t_{4,k}−Σₖ₌₁³t_{1,k})−(Σₖ₌₁³t_{3,k}−Σₖ₌₁t_{2,k}) (1)

In some implementations, the range indication is the RTT. Additionally or alternatively, in some implementations, the first wireless device 602a may determine an actual approximate distance between itself and the second wireless device 602b, for example, by multiplying the RTT by an approximate speed of light in the wireless medium. In such instances, the range indication may additionally or alternatively include the distance value. Additionally or alternatively, the range indication may include an indication as to whether the second wireless device 602b is within a proximity (for example, a service discovery threshold) of the first wireless device 602a based on the RTT. In some implementations, the first wireless device 602a may then transmit the range indication to the second wireless device 602b, for example, in a range report 624 at time t_{5,1}, which the second wireless device receives at time t_{5,2}.

As described above, STAs may be configured to support neighbor awareness, such that the wireless network may operate as a NAN. NAN-compliant STAs may be configured to exchange service discovery frames to determine whether another NAN-compliant STA supports ranging operations. Ranging operations may involve an exchange of FTM frames between at least a pair of NAN-compliant STAs (e.g., an initiating STA and a responding STA). The ranging operation may allow the initiating STA to determine if the responding STA is within a service range of the initiating STA. However, FTM frames are not encrypted and may be susceptible to an attack from an attacking device.

Although the following description discusses NAN-compliant STAs that may communicate using a WLAN protocol, the concepts described herein may be applicable to other similar areas and is not intended to be limited to the examples disclosed herein. For example, STAs may use other protocols, alone or in combination with WLAN protocol, to communicate with each other, such as but not limited to Bluetooth® (BT), Bluetooth Low Energy (BLE), or any other personal area network (PAN) protocol.

The attacking device may detect the initiation of an FTM session between a pair of STAs (e.g., an initiating STA and a responding STA). The attacking device, when the packets used for timing measurements are being transmitted, may transmit a replica of the packet from the responding STA with a slightly earlier timing. For example, the LTF sequence used by the packets for timing measurements is specified in the 802.11 standard, and as such, is known to the general public, allowing anyone, especially the attacker, to replicate the packet. The attacker sending a replica packet with earlier timing may fool or trick the initiating STA into believing that the distance between the initiating STA and the responding STA (or attacking device pretending to be the responding STA) is shorter than the actual distance. For example, a car key (e.g., responding STA) may be in a building 50 meters away, but the attacker may fool the car (e.g., initiating STA) to believe that the key is only 1 meter away.

Some instances are developing a next generation positioning system that makes distance measurements more secure (e.g., IEEE 802.11, TGaz (11az)). However, the changes needed to support and/or implement the next generation positioning system may be substantial, and may take an extended period of time to be adopted in the marketplace.

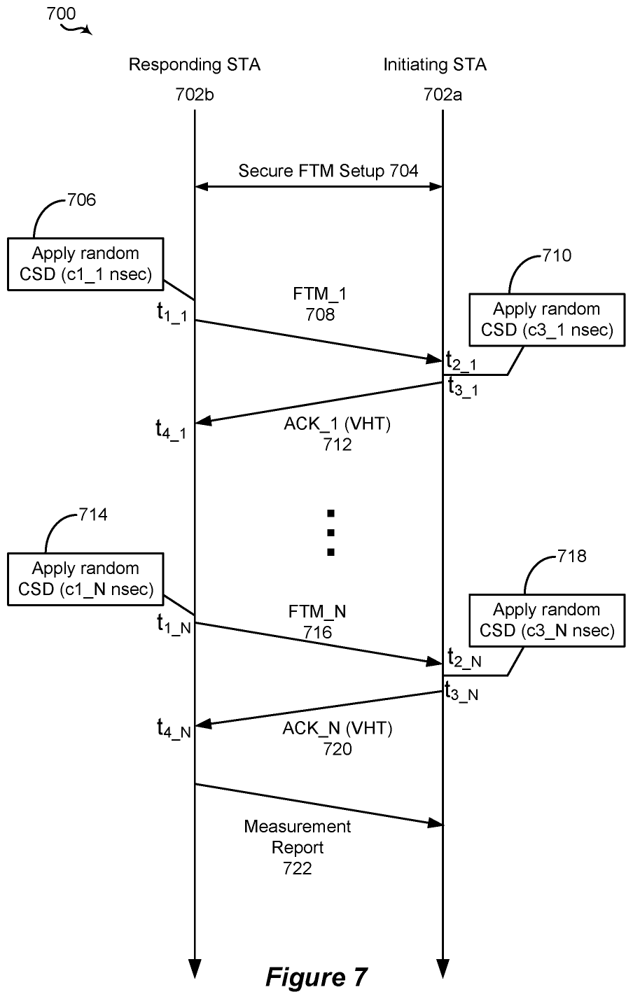

FIG. 7 is a diagram illustrating an exemplary FTM process 700 according to some implementations. As illustrated in FIG. 7, a first STA 702a (e.g., initiating STA) initiates a secure FTM setup 704 with a second STA 702b (e.g., responding STA). In the initiation of the FTM setup, the first STA 702a may indicate to the second STA 702b that CSD should be used for the transmissions or a subset of the transmissions (e.g., by only one of the first STA 702a or the second STA 702b). In one configuration, the FTM setup 704 may indicate that CSD should be used by the first STA 702a or the second STA 702b, or by both the first STA 702a and the second STA 702b. Use of CSD by the first STA 702a helps prevent the first STA 702a from obtaining timing measurement misinformation due to an attack on the second STA 702b. Use of CSD by the second STA 702b helps prevent the first STA 702a from obtaining timing measurement misinformation due to an attack on the first STA 702a. During the FTM setup process, the first STA 702a may also indicate a number N of sets of FTM/ACK packet transmissions that should occur.

The following description assumes that CSD is configured for both the first STA 702a and the second STA 702b. After the FTM setup, the second STA 702b generates an FTM packet (e.g., FTM_1 708) including at least one preamble and data. The second STA 702b applies a random CSD c1_1 706 to one or more preambles within the FTM packet 708. In some implementations, the second STA 702b applies the random CSD c1_1 706 to at least one non-legacy preamble within the FTM packet 708. In some implementations, the second STA 702b may apply the random CSD to a legacy preamble and data within the FTM packet 708. After application of the random CSD c1_1 706, the FTM packet 708 is sent by the second STA 702b at time t1_1 and is received by the first STA 702a at time t2_1. As a result of the CSD c1_1 706, the first STA 702a determines that the FTM packet 708 arrived at time t2_1−c1_1. In response to receiving the FTM packet 708, the first STA 702a generates an ACK packet 712 (e.g., ACK_1) including at least one preamble and data, which includes the ACK itself. The first STA 702a applies a random CSD c3_1 710 to one or more preambles within the ACK packet 712. In some implementations, the first STA 702a applies the random CSD c3_1 710 to at least one non-legacy preamble within the ACK packet 712. In some implementations, the first STA 702a may apply the random CSD to a legacy preamble and data within the ACK packet 712. After application of the random CSD c3_1 710, the ACK packet 712 is sent by the first STA 702a at time t3_1 and is received by the second STA 702b at time t4_1. As a result of the CSD c3_1 710, the second STA 702b determines that the ACK packet 712 arrived at time t4_1−c3_1. This process is repeated by the first and second STAs 702a, 702b for each i^{th} individual set of FTM/ACK packet transmissions for i=2, . . . , N of transmitted FTM packet and ACK packet, where the first STA 702a receives the FTM packet subject to a random CSD from the second STA 702b, and sends an ACK packet subject to a random CSD to the second STA 702b in response to receiving the FTM packet from the second STA 702b.

After the N sets of FTM/ACK transmissions (e.g., FTM_N 716, ACK_N 720), the second STA 702b adjusts t1_m by the corresponding CSD c1_m (e.g., 710). Specifically, the second STA 702b sets t1_m=t1_m−c1_m for m 1, . . . , N. The second STA 702b then sends an encrypted measurement report 722 to the first STA 702a where the report 722 indicates t1_m, t4_m for m 1, . . . , N. The first STA 702a receives the encrypted measurement report 722. The first STA 702a may adjust t3_m by the corresponding CSD c3_m (e.g., 718). Specifically, the first STA 702a may set t3_m=t3_m−c3_m form 1, . . . , N. Alternatively, the first STA 702a may adjust t4_m by the corresponding CSD c3_m (e.g., 718), and specifically may set t4_m=t4_m+c3_m. After the adjustments to t3_m or t4_m based on the CSD c3_m, the first STA 702a may determine a RTT between the first and second STAs 702a, 702b based on the following equation:

$$\begin{matrix}R T T = \frac{1}{N} ( {\sum }_{m = 1}^{N} {t}_{4 \_m} - {\sum }_{m = 1}^{N} {t}_{1 \_m} ) - ( {\sum }_{m = 1}^{N} {t}_{3 \_m} - {\sum }_{m = 1}^{N} {t}_{2 \_m} ) , & ( EQ . 1 )\end{matrix}$$

where for any m t2_m=t2_m−c1_m, t1_m=t1_m−c1_m, t4_m=t4_m−c3_m, and t3_m=t3_m−c3_m. As can be seen in the equation, the CSD terms c1_m, c3_m cancel out from the equation, and therefore the first STA 702a may be able to calculate the RTT between the first and second STAs 702a, 702b even though a CSD is applied.

As discussed above, use of the random CSD helps prevent the first STA 702a from obtaining timing measurement misinformation due to an attack. Assuming that an attacker STA sends a fake FTM packet to the first STA 702a at a time ε2 seconds before time t2_m, where ε2>c1_m, then the first STA 702a may determine a distance between the first and second STAs 702a, 702b based on the equation (1), where for any m t2_m=t2_m−ε2, t1_m=t1_m−c1_m, t4_m=t4_m−c3_m, and t3_m=t3_m−c3_m. As can be seen in the EQ. (1), the CSD term c3_m cancels out from the equation, but the CSD term c1_m does not cancel out from the equation, resulting in the distance equation being based on −ε2+c1_m. The term −ε2+c1_m will vary, as c1_m is randomized, and an attacker cannot predict the value of c1_m in order to vary the value of ε2 correspondingly.

Assuming that an attacker STA sends a fake ACK packet to the second STA 702b at a time ε4 seconds before time t4_m, where ε4>c3_m, then the first STA 702a may determine a distance between the first and second STAs 702a, 702b based on EQ. (1), where for any m t2_m=t2_m−c1_m, t1_m=t1_m−c1_m, t4_m=t4_m−c4, and t3_m=t3_m−c3_m. As can be seen in the equation, the CSD term c1_m cancels out from the equation, but the CSD term c3_m does not cancel out from the equation, resulting in the distance equation being based on −ε4+c3_m. The term −ε4+c3_m will vary, as c3_m is randomized, and an attacker cannot predict the value of c3_m in order to vary the value of ε4 correspondingly.

Assuming that an attacker STA sends a fake FTM packet to the first STA 702a at a time ε2 seconds before time t2_m, where ε2>c1_m, and sends a fake ACK packet to the second STA 702b at a time ε4 seconds before time t4_m, where ε4>c3_m, then the first STA 702a may determine a distance between the first and second STAs 702a, 702b based on EQ. (1), where for any m t2_m=t2_m−ε2, t1_m=t1_m−c1_m, t4_m=t4_m−ε4, and t3_m=t3_m−c3_m. As can be seen in the equation, the CSD terms c1_m, c3_m do not cancel out from the equation, resulting in the distance equation being based on −ε2+c1_m−ε4+c3_m. The term −ε2+c1_m−ε4+c3_m will vary, as both c1_m and c3_m are randomized, and an attacker cannot predict the values of c1_m and c3_m in order to vary the values of ε2 and ε4 correspondingly.

When the distance calculations vary as a result of an attack (due to the random CSDs c1_m and/or c3_m not canceling out in the distance calculation), the first STA 702a may ignore or disregard the particular set of compromised FTM/ACK transmissions from the distance calculation, or may throw out the entire set of N FTM/ACK transmissions from the distance calculation and start the FTM process anew with the second STA 702b. Note that in the above description, the values for c1_m, c3_m can be positive or negative. Positive values would result in the first and second STAs 702a, 702b determining that the FTM, ACK packets, respectively, arrived earlier than actually received. Negative values would result in the first and second STAs 702a, 702b determining that the FTM, ACK packets, respectively, arrived later than actually received. As ε2 needs to be greater than c1_m to compromise the FTM transmissions, and ε4 needs to be greater than c3_m to compromise the ACK transmissions, the first and second STAs 702a, 702b may configure the CSD values to be positive to make it harder for an attacker to compromise the FTM process.

Referring again to the secure FTM setup, in some implementations, the first and second STAs 702a, 702b may agree to the secure FTM. The FTM setup initiation may be performed in multiple ways, such as for example, Bluetooth Low Energy (BLE) or through an IEEE 802.11 FTM Request. In implementations where IEEE 802.11 FTM Request is used, the FTM Request procedure may be updated such that the FTM Request frame is encrypted. In some implementations, a field may be added to the FTM Request frame to indicate that the FTM session is a secure FTM session. In addition, the number N of FTM exchanges between the first and second STAs 702a, 702b may be determined or preconfigured during the FTM setup initiation.

Referring again to the transmission of the FTM packets, in some implementations, the second STA 702b may transmit the FTM packets based on the VHT PPDU format. In some implementations, the second STA 702b may also use HT or HE PPDU formats. In some implementations, the second STA 702b may apply the random CSD (e.g., c1_m) to the VHT portion (e.g., VHT-STF, VHT-LTF, VHT-SIG-B, data) of the FTM packet. The second STA 702b may be configured to compensate for the applied CSD when logging the ToD of the FTM packets. For example, the ToD of t1_m may be calculated as t1_m=t1_m_raw−c1_m. This removes the need for the first STA 702a to know the value of the random CSD for each FTM frame. The value of the CSD may be random and/or different for each FTM frame. In some implementations, the CSD may comprise known or preconfigured CSD values, where the known or preconfigured CSD values may be within X different sets. The first and second STAs 702a, 702b may randomly select one or more of the known or preconfigured CSD values. In some implementations, each of the X different sets of known or preconfigured CSD values may include different sets of known or preconfigured CSD values. The sets of known or preconfigured CSD values may be agreed upon during the initiation of the secure FTM session.

In some implementations, the first STA 702a may be configured to transmit the ACK based on the VHT PPDU format. In some implementations, the first STA 702a may also use HT or HE PPDU formats. The first STA 702a may apply the random CSD (e.g., c3_m) to the VHT portion (e.g., VHT-STF, VHT-LTF, VHT-SIG-B, data) of the FTM packet. The first STA 702a may be configured to compensate for the applied CSD when logging the ToD of the ACKs. For example, the ToD of t3_m may be calculated as t3_m=t3_m raw−c3_m. This removes the need for the second STA 702b to know the value of the random CSD for each ACK. The value of the CSD may be random and/or different for each ACK. In some implementations, the first STA 702a may be configured to compensate for the CSD value when receiving the value of t4_m which represents the time of arrival of the ACKs at the second STA 702b. For example, t4_m may be calculated as t4_m=t4_m−c3_m, where c3_m is the CSD value applied to the ACKs by the first STA 702a.

Referring again to the transmission of the measurement report, the second STA 702b may prepare and transmit the measurement report to the first STA 702a. In some implementations, the measurement report may include the ToD for each of the FTM packets (e.g., FTM_1 708, FTM_N 716) transmitted to the first STA 702a, and the ToA for each of the ACKs (e.g., ACK_1 712, ACK_N 720) sent by the first STA 702a and received at the second STA 702b. In some implementations, the measurement report may be encrypted in order to prevent an attacker from sending a fake measurement report to the first STA 702a. The measurement report may be transmitted by the second STA 702b using various technologies. For example, the second STA 702b may transmit the measurement report frame via BLE or through an encrypted 802.11 standard. In some implementations, the second STA 702b may use 802.11 FTM Measurement Report, that has been updated to include encryption, to transmit the measurement report. For example, the 802.11 FTM Measurement Report may include an additional field to indicate that the FTM Measurement Report frame is a secure or encrypted transmission.

In instances where an attacker is not present, the first STA 702a should calculate a similar RTT and/or distance based on the N sets of FTM measurements. The random CSD values associated with a respective one of the FTM measurements would be removed or accounted for in the measurements. Each of the N sets of FTM measurements should result in a consistent calculated RTT and/or distance. In instances where an attacker is present, the attacker trying to send a replica of the FTM and/or ACK frames would result in the calculated RTT and/or distance varying a lot within the N sets of FTM measurements, because the attacker does not know the value of the random CSDs applied to each of the FTM and/or ACK frames. Thus, by conducting a check to determine that the calculated distance is consistent between the N sets of FTM measurements, the first STA 702a may be configured to determine if one or more of the N sets of FTM measurements is reliable or not. The first STA 702a may be configured to determine the distance based on a set of consistent RTTs. In some implementations, the first STA 702a may ignore or discard one or more of the N sets of FTM measurements in instances where the calculated RTT and/or distance is not consistent with the N sets of FTM measurements. In some implementations, the first STA 702a may discard or ignore all of the N sets of FTM measurements in instances where there is no consistency between the calculated RTTs and/or distances.

The first and second STAs 702a, 702b may be configured to determine whether the ranging operation should be performed. In some implementations, prior to setting up the secure FTM session, the first and second STAs 702a, 702b may estimate their current distance to determine if the ranging operation should be performed. For example, the first and second STAs 702a, 702b may determine that their distance is too far in order to perform the ranging operation. In some implementations, such as when BLE or WLAN is used for prior management frame exchanges, the transmission power of BLE or WLAN (or any other communications systems involved) may be reduced, such that the management frame exchanges would fail in instances where the first and second STAs 702a, 702b are far apart. In some implementations, the BLE or WLAN (or other systems) receiver may measure the received signal strength (RSS) of the packets, and may determine not to initiate the ranging operation in instances where the RSS of the packets is too low. The RSS of the packets being too low, or lowering the transmission power would prevent the ranging operation from performing because the first and second STAs 702a, 702b would be too far apart to allow for the ranging operation to be performed. In instances where the first and second STAs 702a, 702b are close to each other, lowering the transmission power would still allow for the ranging operation to be performed, because the packets could still be received by either the first and second STAs 702a, 702b. In addition, the measured RSS of the packets would not be too low in instances where the first and second STAs 702a, 702b are within range of each other. As such, measuring the RSS and/or reducing the transmission power may be an additional layer(s) of security to ensure that the secure FTM session should be initiated.

Referring again to the initiation of the secure FTM session, in some implementations, for example during the initiation of the secure FTM session, the first and second STAs 702a, 702b may be configured to exchange encrypted messages. The encrypted messages may indicate one or more ranging sets. Each of the one or more ranging sets may include N FTM/ACK exchanges, and the random CSD may be applied at this level. In some implementations, each of the one or more ranging sets may be in different channels. The channels of each of the one or more ranging sets may be indicated in the initiation of the secure FTM session. Each of the one or more ranging sets being in different channels may prevent an attack. For example, if the attacker is unable to find or locate the channel, then the attacker will be unable to perform a cyclic prefix (CP) replay attack. Each of the one or more exchanges within a ranging set may be in different channels. The channels of each of the exchanges may be indicated in the initiation of the secure FTM session. Each of the exchanges being in different channels may prevent an attack. For example, if the attacker is unable to find or locate the channel, then the attacker will be unable to perform a CP replay attack. Each of the one or more ranging sets being in different channels may assist in preventing an attack because it would be harder or more difficult for the attacker to know which channel to look for to attack. In some implementations, the one or more ranging sets may include K ranging sets.

In some implementations, the first and second STAs 702a, 702b may be configured to transmit the FTM/ACK packets on non-standard channels. The first and second STAs 702a, 702b may utilize a center frequency which is not a typical or regular WLAN channel. In instances where BLE is used to setup the secure FTM session, a center frequency may be selected to setup the secure FTM session that is not a typical or regular WLAN channel. For example, a center frequency of 5205 MHz may be selected to be used to setup the secure FTM session, where 5210 MHz is a typical or regular center frequency for VHT80 in U-NII1. The selected center frequency may deviate from a typical or regular center frequency by any value. In the example presented herein, the selected center frequency was 5 MHz less than the typical or regular center frequency of 5210 MHz. However, the selected center frequency may deviate from the typical of regular center frequency by more than 5 MHz or less than 5 MHz, and is not intended to be limited to the implementations disclosed herein. Selecting a center frequency that is not a typical or regular center frequency may assist in preventing an attack, because it would be harder or more difficult for an attacker to know where or which frequency the FTM/ACK signals would be.

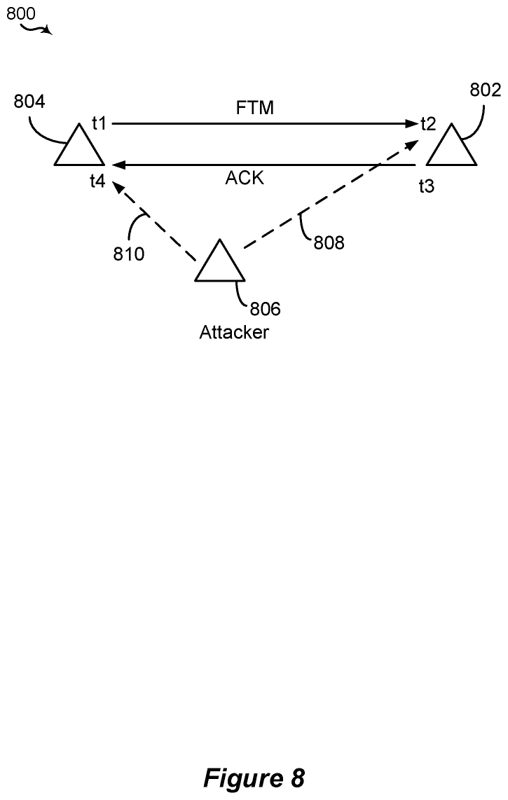

FIG. 8 is a diagram 800 illustrating an exemplary FTM process according to some implementations. The diagram 800 illustrates an exemplary FTM process including the influence of an attacker 806 on the FTM process. The attacker 806 could be an LTF sequence attacker and/or CP replay attacker. The second STA 804 sends the FTM packet at t1, but the actual time that the second STA 804 sends the FTM packet may be t1−ϕ, where ϕ is a bias in timestamps between the first and second STAs 802, 804. Similarly, t4 may be t4−ϕ. As discussed above, the attacker may cause errors ε2, ε4. The error ε2 may be caused due to the attacker 806 sending the fake or replica FTM packet 808 to the first STA 802. The error ε4 may be caused due to the attacker 806 sending the fake ACK 810 to the second STA 804. Accordingly, the difference between t2 and t1 may be A=τ+ϕ−ε2, and the difference between t4 and t3 may be B=τ−ϕ−ε4, where τ is the true RTT divided by 2. The calculated RTT would then be A+B=2τ−ε2−ε4, which is the true RTT with the additional error −ε2−ε4 as a result of the attacker 806. The difference between A and B is A−B=2ϕ−ε2+ε4. The value for ϕ may be precalibrated, and therefore the first STA 802 may know the value for ϕ. As such, the first STA 802 may determine whether β=|A−B−2ϕ| (which is excess timing error greater than 2ϕ caused by the attacker) is less than c (i.e., β=|A−B−2ϕ−<ε), where the threshold c may also be preconfigured. When the first STA 802 determines β≤ε, the first STA 802 may determine that there is no attacker and therefore that the data from the FTM process may be trusted. However, when the first STA 802 determines β>ε, the first STA 802 may determine that there is an attacker and therefore that the data from the FTM process may not be trusted. Accordingly, when −ε2+ε4>ε, the first STA 802 determines that there is an attacker, and otherwise determines that there is no attacker. The threshold c may be set to limit the influence an attacker may have on the error, as any error greater than c in the distance calculation due to an attacker will result in the data being discarded for the distance calculation.

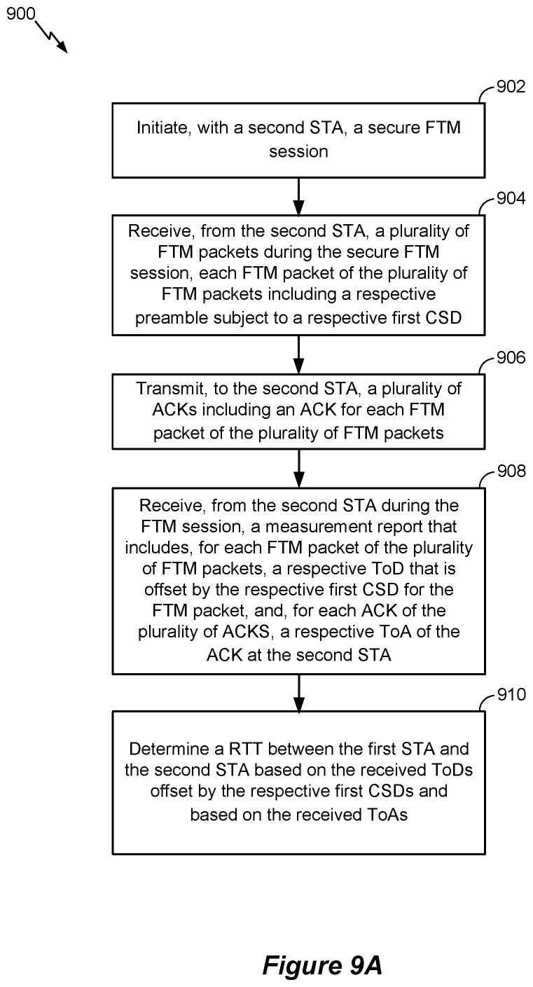

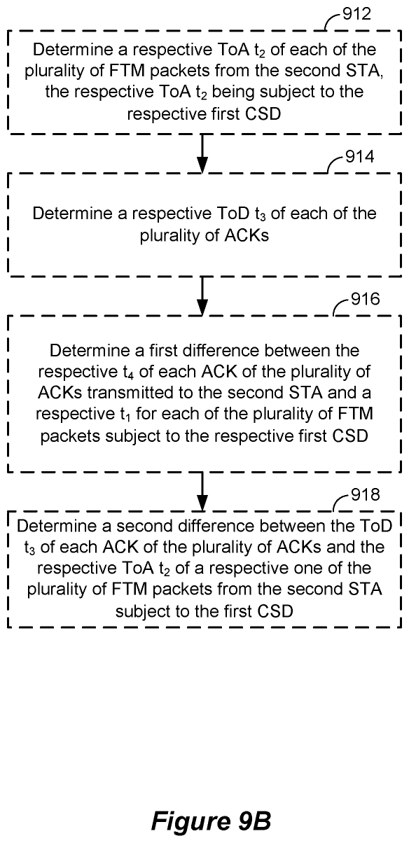

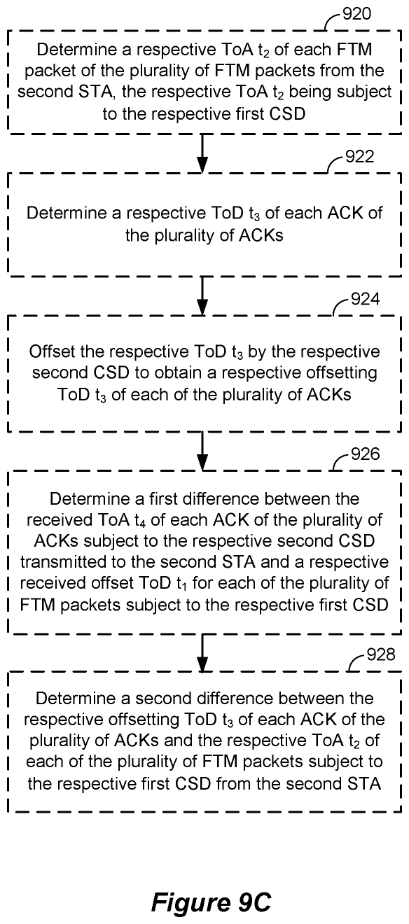

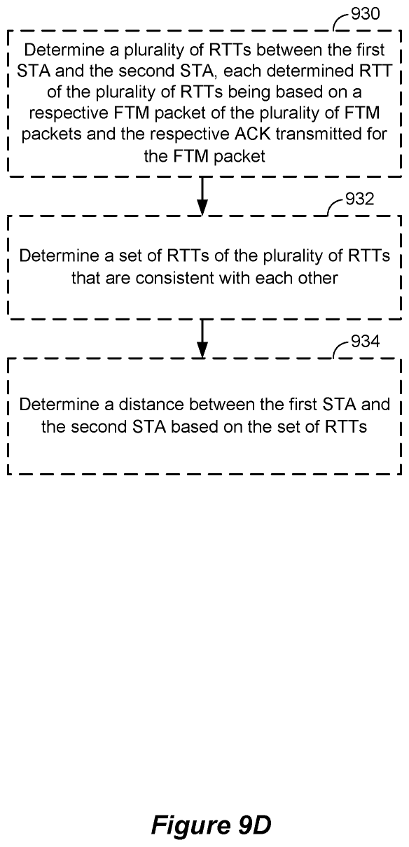

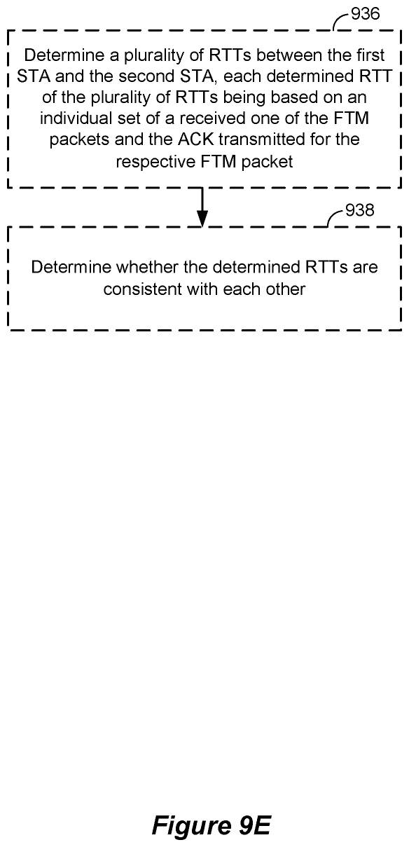

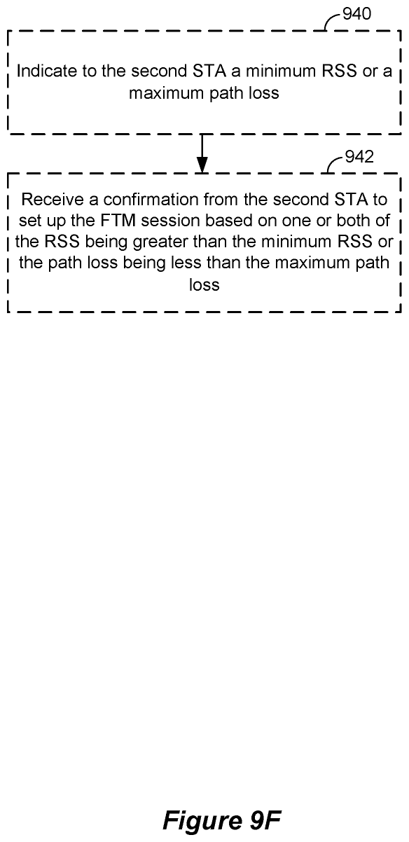

FIG. 9A shows a flowchart illustrating an example process 900 for conducting a secure FTM session according to some implementations. In some implementations, the process 900 may be performed by a wireless communication device such as one of the STAs 104, 304, 500, 602a, 602b, 702a, 702b, 802, 804 described above with reference to FIGS. 1, 3, 5, 6, 7, and 8 respectively. In some implementations, the process 900 begins in block 902 with initiating, with a second STA, a secure FTM session, for example as shown in 704 of FIG. 7. In some implementations, initiating the FTM session may include transmitting a FTM request that indicates that each of the respective first CSDs will be randomized in the secure FTM session. In some implementations, initiation of the FTM session may include transmitting an FTM request that indicates a number N of FTM transmissions for the FTM session, where the plurality of FTM packets consists of N FTM packets and the plurality of ACKs consists of N ACKs. The receiving of the at least one FTM packet may include receiving N FTM packets. The transmission of the ACK for each of the plurality of FTM packets may include transmitting N ACKs. Each of the N ACKs may be for a respective one of the N FTM packets.

In block 904, the process 900 proceeds with receiving, from the second STA, a plurality of FTM packets during the secure FTM session, for example as shown as t2_1 in FIG. 7. Each of the plurality of FTM packets may include at least one preamble subject to a respective first CSD, for example as shown in 706 of FIG. 7. In some implementations, the first CSD may be randomized in each of the plurality of FTM packets.

In block 906, the process 900 proceeds with transmitting, to the second STA, a plurality of ACKs including an ACK for each FTM packet of the plurality of FTM packets, for example as shown by ACK packet 712 of FIG. 7. In some implementations, the plurality of FTM packets received from the second STA and the plurality of ACKs transmitted for each of the plurality of FTM packets comprises N individual sets of one of the received FTM packets and ACK transmitted for the respective FTM packet. The frequency used for each set of received FTM packets and transmitted ACKs may be based on a frequency hopping pattern.

In block 908, the process 900 proceeds with receiving, during the FTM session, a measurement report from the second STA, for example as shown at 722 of FIG. 7. The measurement report may include a ToD offset by the first CSD (e.g., 706, 714) for each FTM packet of the plurality of FTM packets. The measurement report may include for each ACK of the plurality of ACKs, a respective ToA of the ACK at the second STA, for example as shown as t4_1 or t4_N of FIG. 7. In some implementations, the measurement report may be encrypted. The measurement report may be decrypted to obtain the ToD for each of the at least one FTM packets from the second STA to the first STA. The measurement report may be decrypted to obtain to ToA of the ACK at the second STA for each of the at least one ACKs transmitted to the second STA.

In block 910, the process 900 proceeds with determining a RTT between the first STA and the second STA based on the received ToDs offset by the respective first CSDs and based on the received ToAs. In some implementations, the ToD for each of the plurality of FTM packets from the second STA to the first STA may be offset by the respective first CSD. In some implementations, each ACK may be transmitted in a respective packet that includes a preamble subject to a respective second CSD. The ToA of each ACK of the plurality of ACKs may be offset due to the respective second CSD. The determination of the RTT between the first STA and the second STA may be based on the ToA of each ACK of the plurality of ACKs. The received offset ToD for each of the plurality of FTM packets subject to the first CSD may be t1. The received ToA for each of the plurality of ACKs subject to the respective second CSD transmitted to the second STA is t4. The ToD for each of the plurality of ACKs transmitted to the second STA may be offset by the respective second CSD. The respective second CSD may be randomized in each of the plurality of ACKs transmitted to the second STA.

In some implementations, for example as shown in FIG. 9F, the initiation of the secure FTM session in block 902 includes block 940 which includes indicating to the second STA a minimum RSS or a maximum path loss. The initiation of the secure FTM session in block 902 may further include block 942 which includes receiving a confirmation from the second STA to set up the FTM session based on one or both of the RSS being greater than the minimum RSS or the path loss being less than the maximum path loss.

In some implementations, the received offset ToD for each of the at least one received FTM packets subject to the first CSD is t1, and the received ToA of the ACK for each of the at least one ACKs transmitted to the second STA is t4. In some implementations, for example as shown in FIG. 9B, the process 900 may include block 912 which includes determining a respective ToA t2 of each FTM packet of the plurality of FTM packets from the second STA, the determined ToA t2 being subject to the respective first CSD. The process 900 may proceed to block 914 which includes determining a respective ToD t3 of each ACK of the plurality of ACKs. The process 900 may proceed to block 916 which includes determining a first difference between the respective t4 of each ACK of the plurality of ACKs transmitted to the second STA and the respective t1 for each FTM packet of the plurality of FTM packets subject to the respective first CSD. The process 900 may proceed to block 918 which includes determining a second difference between the ToD t3 of each ACK of the plurality of ACKs and the respective ToA t2 of a respective one of the plurality of FTM packets from the second STA subject to the first CSD. The RTT between the first STA and the second STA may be based on a third difference between the first difference and the second difference. The process 900 may further include determining β according to β=t2+t3−t4−t1−2ϕ, where ϕ is a first threshold and where the determination of the RTT is based on |β| being less than a second threshold ε.

In some implementations, the received offset ToD for each of the plurality of FTM packets subject to the respective first CSD is t₁, and the received ToA of each of the plurality of ACKs subject to the respective second CSD transmitted to the second STA is t₄. In some implementations, for example as shown in FIG. 9C, the process 900 may include block 920 which includes determining a respective ToA t₂ of each of the plurality of FTM packets from the second STA, the respective ToA t₂ being subject to the respective first CSD. The process 900 may proceed to block 922 which includes determining a respective ToD t₃ of each ACK of the plurality of ACKs. The process 900 may proceed to block 924 which includes offsetting the respective ToD t₃ by the respective second CSD to obtain a respective offsetting ToD t₃ of each ACK of the plurality of ACKs. The process 900 may proceed to block 926 which includes determining a first difference between the received ToA t₄ of each ACK of the plurality of ACKs subject to the respective second CSD transmitted to the second STA and a respective received offset ToD t₁ for each FTM packet of the plurality of FTM packets subject to the respective first CSD. The process 900 may proceed to block 928 which includes determining a second difference between the respective offsetting ToD t₃ of each ACK of the plurality of ACKs and the respective ToA t₂ of each FTM packet of the plurality of FTM packets subject to the respective first CSD from the second STA. The RTT between the first STA and the second STA may be based on a third difference between the first difference and the second difference. The process 900 may further include determining β according to β=t2+t3−t4−t1−2ϕ, where ϕ is a first threshold and where the determination of the RTT is based on |β| being less than a second threshold ε.

In some implementations, for example, as shown in FIG. 9D, the determination of the distance in block 910 includes block 930 which includes determining a plurality of RTTs between the first STA and the second STA, each determined RTT of the plurality of RTTs being based on a respective FTM packet of the plurality of FTM packets and the respective ACK transmitted for the FTM packet. The determination of the distance in block 910 may further include block 932 which includes determining a set of RTTs of the plurality of RTTs that are consistent with each other. The determination of the distance in block 910 may further include block 934 which includes determining a distance between the first STA and the second STA based on the set of RTTs.

In some implementations, for example, as shown in FIG. 9E, the determination of the distance in block 910 includes block 936 which includes determining a plurality of RTTs between the first STA and the second STA, each determined RTT of the plurality of RTTs being based on an individual set of a received one of the FTM packets and the ACK transmitted for the respective FTM packet. The determination of the distance in block 910 may further include block 938 which includes determining whether the determined RTTs are consistent with each other. The distance between the first STA and the second STA may be determined based on the determined RTTs being consistent with each other.

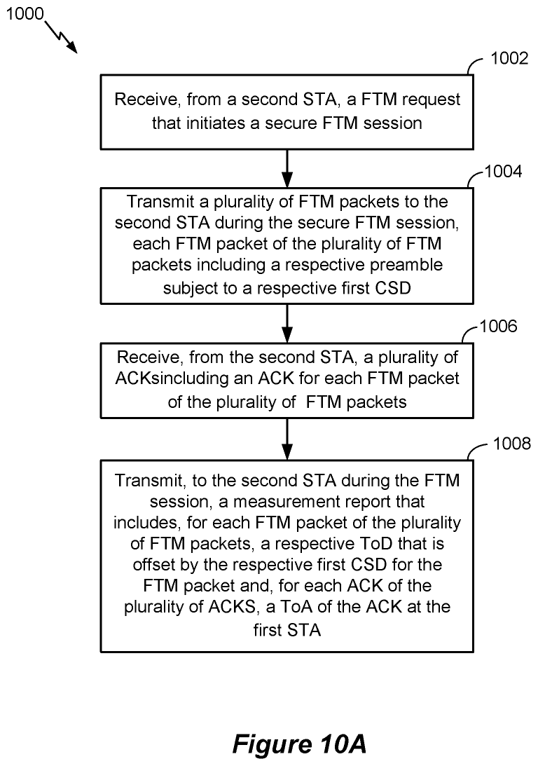

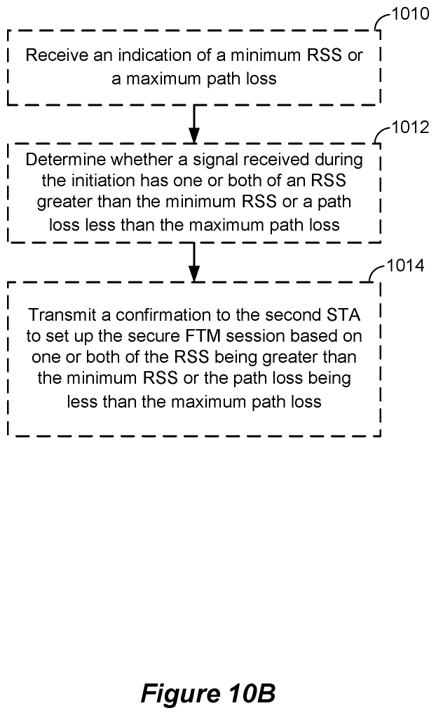

FIG. 10A shows a flowchart illustrating an example process 1000 for performing a secure FTM session according to some implementations. In some implementations, the process 1000 may be performed by a wireless communication device such as one of the STAs 104, 304, 500, 602a, 602b, 702a, 702b, 802, 804 described above with reference to FIGS. 1, 3, 5, 6, 7, and 8 respectively. In some implementations, the process 1000 begins in block 1002 with receiving, from a second STA, a FTM request that initiates a secure FTM session.

In block 1004, the process 1000 proceeds with transmitting a plurality of FTM packets to the second STA during the secure FTM session. Each FTM packet of the plurality of FTM packets includes a respective preamble subject to a respective first CSD.

In block 1006, the process 1000 proceeds with receiving, from the second STA, a plurality of ACKs including an ACK for each FTM packet of the plurality of FTM packets.

In block 1008, the process 1000 proceeds with transmitting, to the second STA during the FTM session, a measurement report. The measurement report may include, for each FTM packet of the plurality of FTM packets, a respective ToD that is offset by the respective first CSD for the FTM packet and, for each ACK of the plurality of ACKs, a ToA of the ACK at the first STA.

In some implementations, for example as shown in FIG. 10B, the method 1000 further includes block 1010 which includes receiving an indication of a minimum RSS or a maximum path loss. The method 1000 may further include block 1012 which includes determining whether a signal received during the initiation from the first STA has an RSS greater than the minimum RSS or a path loss less than the maximum path loss. The method 1000 may further include block 1014 which includes sending a confirmation to the first STA to set up the FTM session when at least one of the RSS is greater than the minimum RSS or the path loss is less than the maximum path loss.

As used herein, a phrase referring to “at least one of” or “one or more of” a list of items refers to any combination of those items, including single members. For example, “at least one of: a, b, or c” is intended to cover the possibilities of: a only, b only, c only, a combination of a and b, a combination of a and c, a combination of b and c, and a combination of a and b and c.

The various illustrative components, logic, logical blocks, modules, circuits, operations and algorithm processes described in connection with the implementations disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

The hardware and data processing apparatus used to implement the various illustrative components, logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some implementations, particular processes, operations and methods may be performed by circuitry that is specific to a given function.

As described above, in some aspects implementations of the subject matter described in this specification can be implemented as software. For example, various functions of components disclosed herein or various blocks or steps of a method, operation, process or algorithm disclosed herein can be implemented as one or more modules of one or more computer programs. Such computer programs can include non-transitory processor- or computer-executable instructions encoded on one or more tangible processor- or computer-readable storage media for execution by, or to control the operation of, data processing apparatus including the components of the devices described herein. By way of example, and not limitation, such storage media may include RAM, ROM, EEPROM, CD-ROM or other optical disk storage, magnetic disk storage or other magnetic storage devices, or any other medium that may be used to store program code in the form of instructions or data structures. Combinations of the above should also be included within the scope of storage media.

Various modifications to the implementations described in this disclosure may be readily apparent to persons having ordinary skill in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, various features that are described in this specification in the context of separate implementations also can be implemented in combination in a single implementation. Conversely, various features that are described in the context of a single implementation also can be implemented in multiple implementations separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

### Some Further Example Clauses

Implementation examples are described in the following numbered clauses:
1. A method for wireless communication at a first station (STA), comprising:

initiating, with a second STA, a secure fine timing measurement (FTM) session;

receiving, from the second STA, a plurality of FTM packets during the secure FTM session, each FTM packet of the plurality of FTM packets including a respective preamble subject to a respective first cyclic shift delay (CSD);

transmitting, to the second STA, a plurality of acknowledgements (ACKs) including an ACK for each FTM packet of the plurality of FTM packets;

receiving, from the second STA during the FTM session, a measurement report that includes, for each FTM packet of the plurality of FTM packets, a respective time of departure (ToD) that is offset by the respective first CSD for the FTM packet, and, for each ACK of the plurality of ACKs, a respective time of arrival (ToA) of the ACK at the second STA; and

determining a round trip time (RTT) between the first STA and the second STA based on the received ToDs offset by the respective first CSDs and based on the received ToAs.

2. The method of clause 1, wherein the received ToD for each of the plurality of FTM packets subject to the respective first CSD is a respective t₁, and the received ToA of the ACK for each of the plurality of ACKs transmitted to the second STA is a respective t₄, and the method further comprises:

determining a respective ToA t₂ of each FTM packet of the plurality of FTM packets from the second STA, the respective ToA t₂ being subject to the respective first CSD;

determining a respective ToD t₃ of each ACK of the plurality of ACKs;

determining a first difference between the respective t₄ of each ACK of the plurality of ACKs transmitted to the second STA and the respective t₁ for each FTM packet of the plurality of FTM packets subject to the respective first CSD; and

determining a second difference between the ToD t₃ of each ACK of the plurality of ACKs and the respective ToA t₂ of a respective one of the plurality of FTM packets from the second STA subject to the first CSD,

wherein the RTT between the first STA and the second STA is based on a third difference between the first difference and the second difference.

3. The method of clause 2, further comprising determining an excess timing error (β) according to β=t2+t3−t4−t1−2ϕ, wherein ϕ is a first threshold and wherein the determination of the RTT is based on |β| being less than a second threshold ε.
4. The method of any of clauses 1-3, further comprising randomly determining each of the first CSDs.
5. The method of any of clauses 1-4, wherein the initiation of the FTM session comprises transmitting a FTM request that indicates that each of the respective first CSDs will be randomized in the secure FTM session.
6. The method of any of clauses 1-5, wherein the initiation of the FTM session comprises transmitting an FTM request that indicates a number N of FTM transmissions for the FTM session, wherein the plurality of FTM packets consists of N FTM packets and the plurality of ACKs consists of N ACKs.
7. The method of any of clauses 1-6, wherein transmitting the plurality of ACKs comprises transmitting each ACK of the plurality of ACKs in a respective packet that includes a preamble subject to a respective second CSD, wherein the ToA of each ACK of the plurality of ACKs is offset due to the respective second CSD, and wherein the determination of the RTT between the first STA and the second STA is based on the ToA of each ACK of the plurality of ACKs.
8. The method of clause 7, wherein the received ToD for each of the plurality of FTM packets subject to the respective first CSD is a respective t₁, wherein the received ToA of the ACK for each of the plurality of ACKs subject to the respective second CSD transmitted to the second STA is a respective t₄, and wherein the method further comprises:

determining a respective ToA t₂ of each of the plurality of FTM packets from the second STA, the respective ToA t₂ being subject to the respective first CSD;

determining a respective ToD t₃ of each ACK of the plurality of ACKs;

offsetting the respective ToD t₃ by the respective second CSD to obtain a respective offsetting ToD t₃ of each ACK of the plurality of ACKs;

determining a first difference between the received ToA t₄ of each ACK of the plurality of ACKs subject to the respective second CSD transmitted to the second STA and a respective received offset ToD t₁ for each FTM packet of the plurality of FTM packets subject to the respective first CSD; and

determining a second difference between the respective offsetting ToD t₃ of each ACK of the plurality of ACKs and the respective ToA t₂ of each FTM packet of the plurality of FTM packets subject to the respective first CSD from the second STA,

wherein the determination of the RTT between the first STA and the second STA is based on a third difference between the first difference and the second difference.

9. The method of clause 7 or 8, wherein transmitting the plurality of ACKs comprises randomly generating the respective second CSD for each ACK of the plurality of ACKs transmitted to the second STA.
10. The method of any of clauses 7-9, wherein a respective second ToD for each of the plurality of ACKs transmitted to the second STA is offset by the respective second CSD.
11. The method of any of clauses 1-10, wherein the measurement report is encrypted and the method further comprises decrypting the measurement report to obtain the respective ToD for each FTM packet of the plurality of FTM packets and to obtain the respective ToA of each ACK of the plurality of ACKs transmitted to the second STA.
12. The method of any of clauses 1-11, further comprising:

determining a plurality of RTTs between the first STA and the second STA, each determined RTT of the plurality of RTTs being based on a respective FTM packet of the plurality of FTM packets and the respective ACK transmitted for the FTM packet;

determining a set of RTTs of the plurality of RTTs that are consistent with each other; and

determining a distance between the first STA and the second STA based on the set of RTTs.

13. The method of any of clauses 1-12, wherein the plurality of FTM packets received from the second STA and the plurality of ACKs transmitted for the plurality of FTM packets comprises N individual sets of a respective FTM packet and the ACK transmitted for the respective FTM packet, and wherein a frequency used for each set of the respective FTM packet and the ACK is based on a frequency hopping pattern.
14. A wireless communication device comprising:

at least one processor; and

at least one memory communicatively coupled with the at least one processor and storing processor-readable code that, when executed by the at least one processor, causes the wireless communication device to:
initiate, with a second STA, a secure fine timing measurement (FTM) session;
receive, from the second STA, a plurality of FTM packets during the secure FTM session, each FTM packet of the plurality of FTM packets including a respective preamble subject to a respective first cyclic shift delay (CSD);
transmit, to the second STA, a plurality of acknowledgements (ACKs) including an ACK for each FTM packet of the plurality of FTM packets;
receive, from the second STA during the FTM session, a measurement report that includes, for each FTM packet of the plurality of FTM packets, a respective time of departure (ToD) that is offset by the respective first CSD for the FTM packet, and, for each ACK of the plurality of ACKs, a respective time of arrival (ToA) of the ACK at the second STA; and
determine a round trip time (RTT) between the first STA and the second STA based on the received ToDs offset by the respective first CSDs and based on the received ToAs.
   15. The wireless communication device of clause 14, wherein the received ToD for each of the plurality of FTM packets subject to the respective first CSD is a respective t₁, and the received ToA of the ACK for each of the plurality of ACKs transmitted to the second STA is a respective t₄, wherein the processor-readable code is further configured to cause the wireless communication device to:
determine a respective ToA t₂ of each FTM packet of the plurality of FTM packets from the second STA, the respective ToA t₂ being subject to the respective first CSD;
determine a respective ToD t₃ of each ACK of the plurality of ACKs;
determine a first difference between the respective t₄ of each ACK of the plurality of ACKs transmitted to the second STA and a respective t₁ for each FTM packet of the plurality of FTM packets subject to the respective first CSD; and
determine a second difference between the ToD t₃ of each ACK of the plurality of ACKs and the respective ToA t₂ of a respective one of the plurality of FTM packets from the second STA subject to the first CSD,
wherein the RTT between the first STA and the second STA is based on a third difference between the first difference and the second difference.
   16. The wireless communication device of clause 15, wherein the processor-readable code is further configured to cause the wireless communication device to determine an excess timing error (β) according to β=t2+t3−t4−t1−2ϕ, wherein ϕ is a first threshold and wherein the wireless communication device determines the RTT based on |β| being less than a second threshold ε.
   17. The wireless communication device of any of clauses 14-16, wherein the respective first CSD is randomized for each of the plurality of FTM packets.
   18. The wireless communication device of any of clauses 14-17, wherein the processor-readable code is configured to cause the wireless communication device to initiate the FTM session by transmitting a FTM request that indicates that each of the first CSDs will be randomized in the secure FTM session.
   19. The wireless communication device of clause any of clauses 14-18, wherein the processor-readable code is configured to cause the wireless communication device to initiate the FTM session by transmitting a FTM request that a number N of FTM transmissions for the FTM session, wherein the plurality of FTM packets consists of N FTM packets, and the plurality of ACKs consists of N ACKs.
   20. The wireless communication device of any of clauses 14-19, wherein the processor-readable code is configured to cause the wireless communication device to transmit each ACK of the plurality of ACKs in a respective packet that includes a preamble subject to a respective second CSD, wherein the ToA of each ACK of the plurality of ACKs is offset due to the respective second CSD, and wherein the determination of the RTT between the first STA and the second STA is based on the ToA of each ACK of the plurality of ACKs.
   21. The wireless communication device of clause 20, wherein the received ToD for each of the plurality of FTM packets subject to the respective first CSD is a respective t₁, wherein the received ToA of the ACK of each of the plurality of ACKs subject to the respective second CSD transmitted to the second STA is a respective t₄, wherein the processor-readable code is further configured to cause the wireless communication device to:
determine a respective ToA t₂ of each FTM packet of the plurality of FTM packets from the second STA, the respective ToA t₂ being subject to the respective first CSD;
determine a respective ToD t₃ of each ACK of the plurality of ACKs;
offset the respective ToD t₃ by the respective second CSD to obtain a respective offsetting ToD t₃ of each of the plurality of ACKs;
determine a first difference between the received ToA t₄ of each ACK of the plurality of ACKs subject to the respective second CSD transmitted to the second STA and a respective received offset ToD t₁ for each of the plurality of FTM packets subject to the respective first CSD; and
determine a second difference between the respective offsetting ToD t₃ of each ACK of the plurality of ACKs and the respective ToA t₂ of each of the plurality of FTM packets subject to the respective first CSD from the second STA,

wherein the determination of the RTT between the first STA and the second STA is based on a third difference between the first difference and the second difference.

22. The wireless communication device of clause 20 or 21, wherein the processor-readable code is further configured to cause the wireless communication device to randomly generate the respective second CSD for each ACK of the plurality of ACKs transmitted to the second STA.
23. The wireless communication device of any of clauses 14-22, wherein the measurement report is encrypted and wherein the processor-readable code is further configured to cause the wireless communication device to decrypt the measurement report to obtain the respective ToD for each FTM packet of the plurality of FTM packets and to obtain the respective ToA of each ACK of the plurality of ACKs transmitted to the second STA.
24. The wireless communication device of any of clauses 14-23, wherein the processor-readable code is further configured to cause the wireless communication device to:

determine a plurality of RTTs between the first STA and the second STA, each determined RTT of the plurality of RTTs being based on a respective FTM packet of the plurality of FTM packets and the respective ACK transmitted for the FTM packet;

determine a set of RTTs of the plurality of RTTs that are consistent with each other; and

determine a distance between the first STA and the second STA based on the set of RTTs.

25. A method for wireless communication at a wireless device at a first station (STA) comprising:

receiving, from a second STA, a fine timing measurement (FTM) request that initiates a secure FTM session;

transmitting a plurality of FTM packets to the second STA during the secure FTM session, each FTM packet of the plurality of FTM packets including a respective preamble subject to a respective first cyclic shift delay (CSD);

receiving, from the second STA, a plurality of acknowledgements (ACKs) including an ACK for each FTM packet of the plurality of FTM packets; and

transmitting, to the second STA during the FTM session, a measurement report that includes, for each FTM packet of the plurality of FTM packets, a respective time of departure (ToD) that is offset by the respective first CSD for the FTM packet and, for each ACK of the plurality of ACKs, a time of arrival (ToA) of the ACK at the first STA.

26. The method of clause 25, further comprising:

receiving an indication of a minimum received signal strength (RSS) or a maximum path loss;

determining whether a signal received during the initiation has one or both of an RSS greater than the minimum RSS or a path loss less than the maximum path loss; and

transmitting a confirmation to the second STA to set up the secure FTM session based on one or both of the RSS being greater than the minimum RSS or the path loss being less than the maximum path loss.

27. The method of clause 25 or 26, wherein transmitting the plurality of FTM packets to second first STA comprises randomly generating the respective first CSD for each FTM packet of the plurality of FTM packets.
28. A wireless communication device comprising:

at least one processor; and

at least one memory communicatively coupled with the at least one processor and storing processor-readable code, that, when executed by the at least one processor, causes the wireless communication device to:
receive, from a second STA, a fine timing measurement (FTM) request that initiates a secure FTM session;
transmit a plurality of FTM packets to the second STA during the secure FTM session, each FTM packet of the plurality of FTM packets including a respective preamble subject to a respective first cyclic shift delay (CSD);
receive, from the second STA, a plurality of acknowledgements (ACKs) including an ACK for each FTM packet of the plurality of FTM packets; and
transmit, to the second STA during the FTM session, a measurement report that includes, for each FTM packet of the plurality of FTM packets, a respective time of departure (ToD) that is offset by the respective first CSD for the FTM packet and, for each ACK of the plurality of ACKs, a time of arrival (ToA) of the ACK at the first STA.
   29. The wireless communication device of clause 28, wherein the processor-readable code is further configured to cause the wireless communication device to:

receive an indication of a minimum received signal strength (RSS) or a maximum path loss;

determine whether a signal received during the initiation has one or both of an RSS greater than the minimum RSS or a path loss less than the maximum path loss; and

transmit a confirmation to the second STA to set up the secure FTM session based on one or both of the RSS being greater than the minimum RSS or the path loss being less than the maximum path loss.

30. The wireless communication device of clause 28 or 29, wherein the processor-readable code is configured to cause the wireless communication device to randomly generate the respective first CSD for each FTM packet of the plurality of FTM packets.

What is claimed is:

1. A method for wireless communication at a first station (STA), comprising:
initiating, with a second STA, a secure fine timing measurement (FTM) session;
receiving, from the second STA, a plurality of FTM packets during the secure FTM session, each FTM packet of the plurality of FTM packets including a respective preamble subject to a respective first cyclic shift delay (CSD);
transmitting, to the second STA, a plurality of acknowledgements (ACKs) including an ACK for each FTM packet of the plurality of FTM packets;
receiving, from the second STA during the FTM session, a measurement report that includes, for each FTM packet of the plurality of FTM packets, a respective time of departure (ToD) that is offset by the respective first CSD for the FTM packet, and, for each ACK of the plurality of ACKs, a respective time of arrival (ToA) of the ACK at the second STA; and
determining a round trip time (RTT) between the first STA and the second STA based on the received ToDs offset by the respective first CSDs and based on the received ToAs.

2. The method of claim 1, wherein the received ToD for each of the plurality of FTM packets subject to the respective first CSD is a respective t₁, and the received ToA of the ACK for each of the plurality of ACKs transmitted to the second STA is a respective t₄, and the method further comprises:
determining a respective ToA t₂ of each FTM packet of the plurality of FTM packets from the second STA, the respective ToA t₂ being subject to the respective first CSD;
determining a respective ToD t₃ of each ACK of the plurality of ACKs;
determining a first difference between the respective t₄ of each ACK of the plurality of ACKs transmitted to the second STA and the respective t₁ for each FTM packet of the plurality of FTM packets subject to the respective first CSD; and
determining a second difference between the ToD t₃ of each ACK of the plurality of ACKs and the respective ToA t₂ of a respective one of the plurality of FTM packets from the second STA subject to the first CSD,
wherein the RTT between the first STA and the second STA is based on a third difference between the first difference and the second difference.

3. The method of claim 2, further comprising determining an excess timing error (β) according to β=t2+t3−t4−t1−2ϕ, wherein ϕ is a first threshold and wherein the determination of the RTT is based on |β| being less than a second threshold ε.

4. The method of claim 1, wherein the respective first CSD is randomized for each FTM packet of the plurality of FTM packets.

5. The method of claim 1, wherein the initiation of the FTM session comprises transmitting a FTM request that indicates that each of the respective first CSDs will be randomized in the secure FTM session.

6. The method of claim 1, wherein the initiation of the FTM session comprises transmitting an FTM request that indicates a number N of FTM transmissions for the FTM session, wherein the plurality of FTM packets consists of N FTM packets and the plurality of ACKs consists of N ACKs.

7. The method of claim 1, wherein transmitting the plurality of ACKs comprises transmitting each ACK of the plurality of ACKs in a respective packet that includes a preamble subject to a respective second CSD, wherein the ToA of each ACK of the plurality of ACKs is offset due to the respective second CSD, and wherein the determination of the RTT between the first STA and the second STA is based on the ToA of each ACK of the plurality of ACKs.

8. The method of claim 7, wherein the received ToD for each of the plurality of FTM packets subject to the respective first CSD is a respective t₁, wherein the received ToA of the ACK for each of the plurality of ACKs subject to the respective second CSD transmitted to the second STA is a respective t₄, and wherein the method further comprises:
determining a respective ToA t₂ of each of the plurality of FTM packets from the second STA, the respective ToA t₂ being subject to the respective first CSD;
determining a respective ToD t₃ of each ACK of the plurality of ACKs;
offsetting the respective ToD t₃ by the respective second CSD to obtain a respective offsetting ToD t₃ of each ACK of the plurality of ACKs;
determining a first difference between the received ToA t₄ of each ACK of the plurality of ACKs subject to the respective second CSD transmitted to the second STA and a respective received offset ToD t₁ for each FTM packet of the plurality of FTM packets subject to the respective first CSD; and
determining a second difference between the respective offsetting ToD t₃ of each ACK of the plurality of ACKs and the respective ToA t₂ of each FTM packet of the plurality of FTM packets subject to the respective first CSD from the second STA,
wherein the determination of the RTT between the first STA and the second STA is based on a third difference between the first difference and the second difference.

9. The method of claim 7, wherein transmitting the plurality of ACKs comprises randomly generating the respective second CSD for each ACK of the plurality of ACKs transmitted to the second STA.

10. The method of claim 7, wherein a respective second ToD for each of the plurality of ACKs transmitted to the second STA is offset by the respective second CSD.

11. The method of claim 1, wherein the measurement report is encrypted and the method further comprises decrypting the measurement report to obtain the respective ToD for each FTM packet of the plurality of FTM packets and to obtain the respective ToA of each ACK of the plurality of ACKs transmitted to the second STA.

12. The method of claim 1, further comprising:
determining a plurality of RTTs between the first STA and the second STA, each determined RTT of the plurality of RTTs being based on a respective FTM packet of the plurality of FTM packets and the respective ACK transmitted for the FTM packet;
determining a set of RTTs of the plurality of RTTs that are consistent with each other; and
determining a distance between the first STA and the second STA based on the set of RTTs.

13. The method of claim 1, wherein the plurality of FTM packets received from the second STA and the plurality of ACKs transmitted for the plurality of FTM packets comprises N individual sets of a respective FTM packet and the ACK transmitted for the respective FTM packet, and wherein a frequency used for each set of the respective FTM packet and the ACK is based on a frequency hopping pattern.

14. A wireless communication device comprising:
at least one processor; and
at least one memory communicatively coupled with the at least one processor and storing processor-readable code that, when executed by the at least one processor, causes the wireless communication device to:
initiate, with a second STA, a secure fine timing measurement (FTM) session;
receive, from the second STA, a plurality of FTM packets during the secure FTM session, each FTM packet of the plurality of FTM packets including a respective preamble subject to a respective first cyclic shift delay (CSD);
transmit, to the second STA, a plurality of acknowledgements (ACKs) including an ACK for each FTM packet of the plurality of FTM packets;
receive, from the second STA during the FTM session, a measurement report that includes, for each FTM packet of the plurality of FTM packets, a respective time of departure (ToD) that is offset by the respective first CSD for the FTM packet, and, for each ACK of the plurality of ACKs, a respective time of arrival (ToA) of the ACK at the second STA; and
determine a round trip time (RTT) between the first STA and the second STA based on the received ToDs offset by the respective first CSDs and based on the received ToAs.

15. The wireless communication device of claim 14, wherein the received ToD for each of the plurality of FTM packets subject to the respective first CSD is a respective t₁, and the received ToA of the ACK for each of the plurality of ACKs transmitted to the second STA is a respective t₄, wherein the processor-readable code is further configured to cause the wireless communication device to:
determine a respective ToA t₂ of each FTM packet of the plurality of FTM packets from the second STA, the respective ToA t₂ being subject to the respective first CSD;
determine a respective ToD t₃ of each ACK of the plurality of ACKs;
determine a first difference between the respective t₄ of each ACK of the plurality of ACKs transmitted to the second STA and a respective t₁ for each FTM packet of the plurality of FTM packets subject to the respective first CSD; and
determine a second difference between the ToD t₃ of each ACK of the plurality of ACKs and the respective ToA t₂ of a respective one of the plurality of FTM packets from the second STA subject to the first CSD,
wherein the RTT between the first STA and the second STA is based on a third difference between the first difference and the second difference.

16. The wireless communication device of claim 15, wherein the processor-readable code is further configured to cause the wireless communication device to determine an excess timing error (β) according to β=t2+t3−t4−t1−2ϕ, wherein ϕ is a first threshold and wherein the wireless communication device determines the RTT based on |β| being less than a second threshold ε.

17. The wireless communication device of claim 14, wherein the respective first CSD is randomized for each of the plurality of FTM packets.

18. The wireless communication device of claim 14, wherein the processor-readable code is configured to cause the wireless communication device to initiate the FTM session by transmitting a FTM request that indicates that each of the first CSDs will be randomized in the secure FTM session.

19. The wireless communication device of claim 14, wherein the processor-readable code is configured to cause the wireless communication device to initiate the FTM session by transmitting a FTM request that a number N of FTM transmissions for the FTM session, wherein the plurality of FTM packets consists of N FTM packets, and the plurality of ACKs consists of N ACKs.

20. The wireless communication device of claim 14, wherein the processor-readable code is configured to cause the wireless communication device to transmit each ACK of the plurality of ACKs in a respective packet that includes a preamble subject to a respective second CSD, wherein the ToA of each ACK of the plurality of ACKs is offset due to the respective second CSD, and wherein the determination of the RTT between the first STA and the second STA is based on the ToA of each ACK of the plurality of ACKs.

21. The wireless communication device of claim 20, wherein the received ToD for each of the plurality of FTM packets subject to the respective first CSD is a respective t₁, wherein the received ToA of the ACK of each of the plurality of ACKs subject to the respective second CSD transmitted to the second STA is a respective t₄, wherein the processor-readable code is further configured to cause the wireless communication device to:
determine a respective ToA t₂ of each FTM packet of the plurality of FTM packets from the second STA, the respective ToA t₂ being subject to the respective first CSD;
determine a respective ToD t₃ of each ACK of the plurality of ACKs;
offset the respective ToD t₃ by the respective second CSD to obtain a respective offsetting ToD t₃ of each of the plurality of ACKs;
determine a first difference between the received ToA t₄ of each ACK of the plurality of ACKs subject to the respective second CSD transmitted to the second STA and a respective received offset ToD t₁ for each of the plurality of FTM packets subject to the respective first CSD; and
determine a second difference between the respective offsetting ToD t₃ of each ACK of the plurality of ACKs and the respective ToA t₂ of each of the plurality of FTM packets subject to the respective first CSD from the second STA,
wherein the determination of the RTT between the first STA and the second STA is based on a third difference between the first difference and the second difference.

22. The wireless communication device of claim 20, wherein the processor-readable code is further configured to cause the wireless communication device to randomly generate the respective second CSD for each ACK of the plurality of ACKs transmitted to the second STA.

23. The wireless communication device of claim 14, wherein the measurement report is encrypted and wherein the processor-readable code is further configured to cause the wireless communication device to decrypt the measurement report to obtain the respective ToD for each FTM packet of the plurality of FTM packets and to obtain the respective ToA of each ACK of the plurality of ACKs transmitted to the second STA.

24. The wireless communication device of claim 14, wherein the processor-readable code is further configured to cause the wireless communication device to:
determine a plurality of RTTs between the first STA and the second STA, each determined RTT of the plurality of RTTs being based on a respective FTM packet of the plurality of FTM packets and the respective ACK transmitted for the FTM packet;
determine a set of RTTs of the plurality of RTTs that are consistent with each other; and
determine a distance between the first STA and the second STA based on the set of RTTs.

25. A method for wireless communication at a wireless device at a first station (STA) comprising:
receiving, from a second STA, a fine timing measurement (FTM) request that initiates a secure FTM session;
transmitting a plurality of FTM packets to the second STA during the secure FTM session, each FTM packet of the plurality of FTM packets including a respective preamble subject to a respective first cyclic shift delay (CSD);
receiving, from the second STA, a plurality of acknowledgements (ACKs) including an ACK for each FTM packet of the plurality of FTM packets; and
transmitting, to the second STA during the FTM session, a measurement report that includes, for each FTM packet of the plurality of FTM packets, a respective time of departure (ToD) that is offset by the respective first CSD for the FTM packet and, for each ACK of the plurality of ACKs, a time of arrival (ToA) of the ACK at the first STA.

26. The method of claim 25, further comprising:
receiving an indication of a minimum received signal strength (RSS) or a maximum path loss;
determining whether a signal received during the initiation has one or both of an RSS greater than the minimum RSS or a path loss less than the maximum path loss; and
transmitting a confirmation to the second STA to set up the secure FTM session based on one or both of the RSS being greater than the minimum RSS or the path loss being less than the maximum path loss.

27. The method of claim 25, wherein transmitting the plurality of FTM packets to second first STA comprises randomly generating the respective first CSD for each FTM packet of the plurality of FTM packets.

28. A wireless communication device comprising:
at least one processor; and
at least one memory communicatively coupled with the at least one processor and storing processor-readable code, that, when executed by the at least one processor, causes the wireless communication device to:
receive, from a second STA, a fine timing measurement (FTM) request that initiates a secure FTM session;
transmit a plurality of FTM packets to the second STA during the secure FTM session, each FTM packet of the plurality of FTM packets including a respective preamble subject to a respective first cyclic shift delay (CSD);
receive, from the second STA, a plurality of acknowledgements (ACKs) including an ACK for each FTM packet of the plurality of FTM packets; and
transmit, to the second STA during the FTM session, a measurement report that includes, for each FTM packet of the plurality of FTM packets, a respective time of departure (ToD) that is offset by the respective first CSD for the FTM packet and, for each ACK of the plurality of ACKs, a time of arrival (ToA) of the ACK at the first STA.

29. The wireless communication device of claim 28, wherein the processor-readable code is further configured to cause the wireless communication device to:
receive an indication of a minimum received signal strength (RSS) or a maximum path loss;
determine whether a signal received during the initiation has one or both of an RSS greater than the minimum RSS or a path loss less than the maximum path loss; and
transmit a confirmation to the second STA to set up the secure FTM session based on one or both of the RSS being greater than the minimum RSS or the path loss being less than the maximum path loss.

30. The wireless communication device of claim 28, wherein the processor-readable code is configured to cause the wireless communication device to randomly generate the respective first CSD for each FTM packet of the plurality of FTM packets.
